(19) United States
(12) Patent Application Publication
(10) Pub. No.: US 2025/0144807 A1
(43) Pub. Date: May 8, 2025

(54) DESIGNATION DEVICE, ROBOT SYSTEM, DESIGNATION METHOD, AND RECORDING MEDIUM

(71) Applicant: NEC Corporation, Minato-ku, Tokyo (JP)

(72) Inventors: Masatsugu OGAWA, Tokyo (JP); Masumi ICHIEN, Tokyo (JP)

(73) Assignee: NEC Corporation, Minato-ku, Tokyo (JP)

(21) Appl. No.: 18/730,008

(22) PCT Filed: Feb. 1, 2022
(86) PCT No.: PCT/JP2022/003781

§ 371 Date: Jul. 18, 2024

(51) Int. Cl. B25J 9/16

(52) U.S. Cl. CPC B25J 9/1697

(57) ABSTRACT

A designation device receives an input designating at least a portion of an external form of an object to be moved in a robot system that moves the object to be moved by following a predetermined algorithm in accordance with a work goal. The designation device makes a display device display a two-dimensional image including the object to be moved, and the external form received by the reception means.

### TECHNICAL FIELD

The present disclosure pertains to a designation device, a robot system, a designation method, and a recording medium.

### BACKGROUND ART

Robots are used in various fields such as in goods distribution. Patent Document 1 discloses, as related technology, technology pertaining to a robot system that can easily be taught desired actions.

### PRIOR ART DOCUMENTS

### Patent Document

Patent Document 1: Japanese Unexamined Patent Application, First Publication No. 2014-083610

### SUMMARY

### Technical Problem

Generally, in the case of robots that grasp objects to be moved and place them at movement destinations, the pre-movement states (the positions and postures) of the objects are often recognized by using automatic recognition systems that use expensive cameras known as industrial cameras. However, for example, in a case where objects to be moved contact a plurality of objects, in a case where solid objects and soft objects are intermingled as objects to be moved, in a case where lighting is reflected in objects to be moved, in a case where objects to be moved are shiny, in a case where objects to be moved are transparent, in a case where objects to be moved are wrapped in a cushioning material, and the like, it can be difficult to appropriately recognize individual objects even in a case where industrial cameras are used.

The respective example embodiments of the present disclosure have, as one objective, to provide a designation device, a robot system, a designation method, and a recording medium that can solve the above-mentioned problem.

### Solution to Problem

According to an example embodiment of the present disclosure, a designation device includes a reception means configured to receive an input designating at least a portion of an external form of an object to be moved in a robot system that moves the object to be moved by following a predetermine algorithm in accordance with a work goal, and a control means configured to make a display device display a two-dimensional image including the object to be moved, and the external form received by the reception means.

According to another example embodiment of the present disclosure, a robot system includes the designation device, a robot configured to be capable of grasping an object to be moved, and a control device configured to make the robot grasp the object to be moved based on an external form of the object to be moved, received by the designation device.

According to another example embodiment of the present disclosure, a designation method executed by a computer includes receiving an input designating at least a portion of an external form of an object to be moved in a robot system that moves the object to be moved by following a predetermined algorithm in accordance with a work goal, and making a display device display a two-dimensional image including the object to be moved, and the external form that has been received.

According to another example embodiment of the present disclosure, a recording medium storing a program for causing a computer to receive an input designating at least a portion of an external form of an object to be moved in a robot system that moves the object to be moved by following a predetermined algorithm in accordance with a work goal, and make a display device display a two-dimensional image including the object to be moved, and the external form that has been received.

### Advantageous Effects of Invention

According to the respective example embodiments of the present disclosure, even in the case in which a robot system cannot correctly recognize an object, the object can be made correctly recognizable.

### BRIEF DESCRIPTION OF DRAWINGS

FIG. 1 is a diagram illustrating an example of the configuration of a robot system according to a first example embodiment of the present disclosure.

FIG. 2 is a diagram illustrating an example of installation of a measurement device according to the first example embodiment of the present disclosure.

FIG. 3 is a diagram illustrating an example of the configuration of the measurement device according to the first example embodiment of the present disclosure.

FIG. 4 is a diagram illustrating an example of a region captured by the measurement device according to the first example embodiment of the present disclosure.

FIG. 5 is a diagram illustrating an example of the configuration of a designation device according to the first example embodiment of the present disclosure.

FIG. 6 is a diagram illustrating an example of an image displayed by a display unit according to the first example embodiment of the present disclosure.

FIG. 7 is a diagram illustrating an example of the configuration of a control device according to the first example embodiment of the present disclosure.

FIG. 8 is a diagram illustrating an example of a data table stored in a storage unit according to the first example embodiment of the present disclosure.

FIG. 9 is a diagram illustrating an example of the configuration of a robot according to the first example embodiment of the present disclosure.

FIG. 10 is a diagram illustrating an example of the processing flow in a robot system according to the first example embodiment of the present disclosure.

FIG. 11 is a diagram illustrating an example of installation of a measurement device according to a modified example of the first example embodiment of the present disclosure.

FIG. 12 is a diagram illustrating an example of an image displayed by a display unit according to the modified example of the first example embodiment of the present disclosure.

FIG. 13 is a diagram illustrating an example of the configuration of a robot system according to a second example embodiment of the present disclosure.

FIG. 14 is a diagram illustrating an example of the configuration of an automatic recognition system according to the second example embodiment of the present disclosure.

FIG. 15 is a diagram illustrating an example of installation of a camera according to the second example embodiment of the present disclosure.

FIG. 16 is a diagram illustrating an example of an image displayed by a display unit according to the second example embodiment of the present disclosure.

FIG. 17 is a diagram illustrating an example of an image displayed by a display unit according to a modified example of the second example embodiment of the present disclosure.

FIG. 18 is a diagram illustrating an example of the configuration of a robot system according to a third example embodiment of the present disclosure.

FIG. 19 is a diagram illustrating an example of the configuration of a WMS according to the third example embodiment of the present disclosure.

FIG. 20 is a diagram illustrating an example of a data table stored in a storage unit according to the third example embodiment of the present disclosure.

FIG. 21 is a diagram illustrating an example of an image displayed by a display unit according to the third example embodiment of the present disclosure.

FIG. 22 is a diagram illustrating an example of an image displayed by a display unit according to a modified example of the third example embodiment of the present disclosure.

FIG. 23 is a diagram illustrating an example of the configuration of a robot system according to a fourth example embodiment of the present disclosure.

FIG. 24 is a diagram illustrating an example of a movement destination determined by a control device according to a fifth example embodiment of the present disclosure.

FIG. 25 is a diagram illustrating a designation device with the minimum configuration according to an example embodiment of the present disclosure.

FIG. 26 is a diagram illustrating an example of the processing flow in the designation device with the minimum configuration.

FIG. 27 is a schematic block diagram illustrating the configuration of a computer according to at least one example embodiment.

### EXAMPLE EMBODIMENT

Hereinafter, example embodiments will be explained in detail with reference to the drawings.

### First Example Embodiment

The robot system 1 according to a first example embodiment of the present disclosure is a system in which a worker can designate the pre-movement state of an object. The robot system 1 is a system that is implemented, for example, in a warehouse at a goods distribution center, and the like, for the purpose of grasping objects that have arrived or objects that are to be shipped and moving the objects to predetermined locations at the time of arrival or at the time of shipping. For example, there is technology called “goal-oriented task planning” in which work that used to be performed by humans is executed by using AI (Artificial Intelligence) technology. In a case where this “goal-oriented task planning” is used, a robot can be made to automatically (i.e., without a worker doing anything) execute actions to achieve a work goal simply by a worker at the site at which the robot is being used indicating the work goal. Specifically, in a case where a robot is to grasp objects to be moved and to place the objects at a movement destination, in a case where information such as, for example, “move three of the components A to a tray” is input to the robot as a work goal, the robot grasps three of the components A in order and moves them from pre-movement positions to the movement destination by following a predetermined algorithm in accordance with the work goal.

The robot system 1 is a robot system that, in a case where the pre-movement state of an object is input, moves that object by following a predetermined algorithm in accordance with a work goal. The robot system 1 may be a robot system that uses AI technology including temporal logic, reinforcement learning, and the like. In the first example embodiment, objects M to be moved are placed on and parallel to a planar surface P (on a planar surface of a tray or of a belt conveyor to be described below) that is oriented substantially horizontally.

### (Configuration of Robot System)

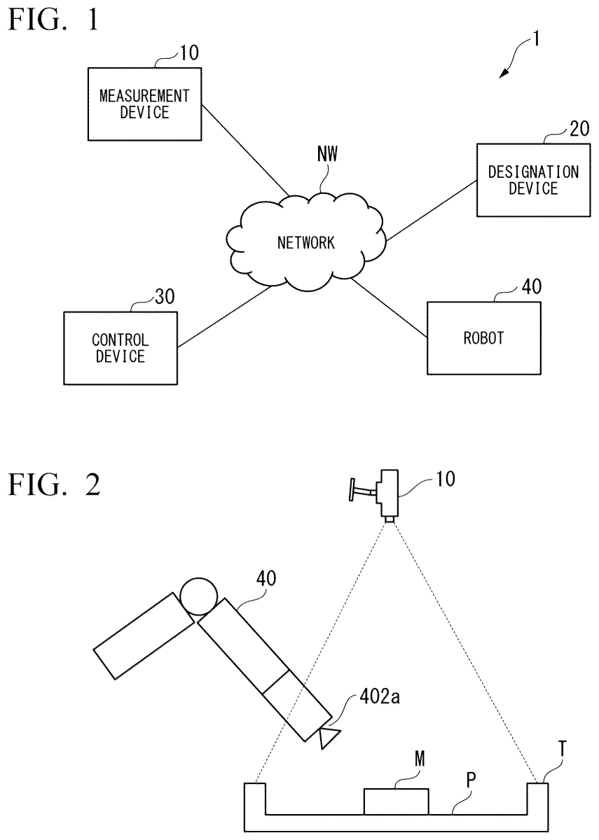

FIG. 1 is a diagram illustrating an example of the configuration of a robot system 1 according to a first example embodiment of the present disclosure. The robot system 1, as shown in FIG. 1, includes a measurement device 10, a designation device 20, a control device 30, and a robot 40. The measurement device 10, the designation device 20, the control device 30, and the robot 40 can each be connected with each other via a network NW The network NW of the present disclosure is not limited to being a communication network like the internet, and may be of any type in which necessary signals are transmitted and received. For example, some of the connections of the measurement device 10, the designation device 20, the control device 30, and the robot 40 may be direct connections with metal wiring, and other connections may be made via a communication network.

### (Configuration of Measurement Device)

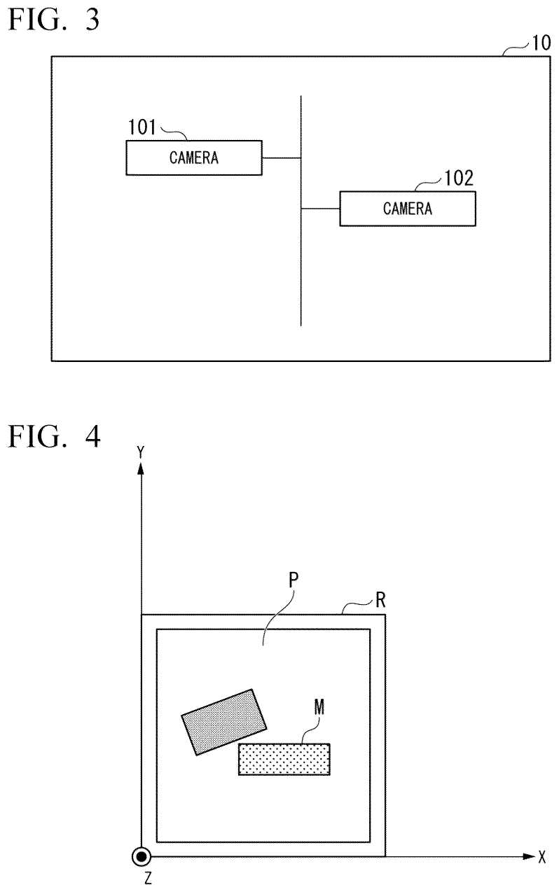

FIG. 2 is a diagram illustrating an example of installation of a measurement device 10 according to the first example embodiment of the present disclosure. FIG. 3 is a diagram illustrating an example of the configuration of the measurement device 10 according to the first example embodiment of the present disclosure. In the example shown in FIG. 2, the measurement device 10 is provided at a fixed position from which images of a planar surface P of a tray T on which objects M to be moved are placed can be captured from above. That is, a camera 101 and a camera 102, to be described below, are provided at fixed positions from which images can be captured, from above, of the planar surface P on which the objects M to be moved are placed.

The work to capture images of the planar surface P from above and to move objects to be moved to the movement destination, at the time of arrival of goods, is work that is performed after a process of opening a container, and the like that has arrived and removing packaging material, and a process of extracting individual goods (hereinafter referred to as “separate items”) from the opened container, and the like have been performed by people, during a process in which the people place the separate items, by the lot, on a belt conveyor, and the robot system 1 sorts the separate items in each lot into trays corresponding to the respective lots. An example of a container is a tray or a box composed of cardboard, and the like. In this case, the separate items are the objects to be moved. Additionally, the surface of the belt conveyor on which the separate items are placed is the planar surface P. Additionally, the trays are the movement destinations.

Additionally, the work to capture images of the planar surface P from above and to move objects to be moved to the movement destination, at the time of shipping, is work that is performed during a process of putting a plurality of goods to be shipped to a certain location in a single container, and the like. At a warehouse, separate items that have arrived are stocked in a state in which they are placed in trays by lots. The separate items that are stocked in the warehouse are each goods, and at the time of shipping, the respective trays in which the goods (i.e., the separate items corresponding to a plurality of goods) to be shipped have been placed are transported sequentially to the position of the robot system 1. In this case, the separate items transported to the position of the robot system 1 on trays are the objects to be moved. Additionally, the surface on which the separate items are placed on a tray that has been transported to the position of the robot system 1 is the planar surface P. Additionally, the container, and the like is the movement destination.

FIG. 2 shows a planar surface P, an object M to be moved that has been placed on the planar surface P, and a robot 40 for grasping and moving the object M to be moved to a predetermined position. Additionally, FIG. 2 illustrates a grasping unit 402a provided on the robot 40, to be described below. The measurement device 10, as shown in FIG. 3, includes a camera 101 and a camera 102. The camera 101 and the camera 102, as shown in FIG. 2, may be housed in a single casing. Alternatively, the camera 101 and the camera 102 may be housed in separate casings.

The camera 101 is a camera that captures two-dimensional (2D) images including at least a portion of the planar surface P and the object M to be moved, which has been placed on the planar surface P. The camera 101 transmits captured image information to the designation device 20 via the network NW.

The camera 102 is a camera that can measure depth, in the image capture direction, of the object to be moved. For example, the camera 102 is a depth camera. The depth camera irradiates an object in an image capture region with light and measures the distance from the camera 102 to the object based on the time (i.e., equivalent to the phase difference) from when the light was emitted until reflected light from the irradiated objected is received. In the first example embodiment, the image capture region of the camera 102 is a region R including at least a portion of the planar surface P and the object M to be moved, which is placed on the planar surface P. The image capture region in which the camera 101 captures the two-dimensional images may be any region, within the region R, that includes at least the object M to be moved, and may be the region R itself. In the explanation below, the explanation will be made under the assumption that the image capture region in which the camera 101 captures two-dimensional images is the region R. FIG. 4 is a diagram illustrating an example of the region R captured by the measurement device 10 according to the first example embodiment of the present disclosure. As shown in FIG. 4, the region R includes the planar surface P and a region in which the object M to be moved is located. In this case, the bottom left corner of the region R is defined as the origin 0, the horizontal axis is defined as the X axis, and the vertical axis is defined as the Y axis. Additionally, the axis perpendicular to the XY plane is defined as the Z axis. On the X axis, the direction from the origin towards the right side of the page is the positive direction. Additionally, on the Y axis, the direction from the origin towards the top of the page is the positive direction. Additionally, on the Z axis, the direction from the origin towards the space in front of the page is the positive direction.

The camera 102 is installed at a fixed location. For this reason, the camera 102 can measure the height in the Z-axis direction, relative to the XY plane, of the object M to be moved by defining the planar surface P to be the region, within the image capture region, at the furthest distance from the camera 102 within an error range from at least the machining precision of the planar surface P to at most the size of the object M, and by calculating the difference between the distance from the camera 102 to the planar surface P and the distance from the camera 102 to the object to be moved in a region of the object M to be moved designated as described below. For example, a region in which the object M is located is identified, and the camera 102 measures the height in the Z-axis direction of the object M to be moved, relative to the XY plane, by calculating the difference between the distance from the camera 102 to the object M and the distance from the camera 102 to the planar surface P. Examples of methods for identifying a region in which the object M is located include a method of presetting a spatial region in which the object M is to be disposed and excluding information regarding other regions, a method of using automatic recognition means (e.g., means for recognizing an object based on 3D CAD (Computer-Aided Design) information of a target object) to identify the position of the object M by matching the shapes of point clouds or to identify the spatial region in which the object M is disposed from images of the object M. Examples of the camera 102 include cameras that estimate distances by using a stereo camera, cameras that irradiate objects with light and that estimate the distances based on the time until reflected light returns, and the like. The camera 102 transmits information indicating measurement results (i.e., information indicating the height of the object M) to a control device 30 via the network NW.

The height of the object M to be moved may be calculated by using the difference between the distance from a LiDAR to the object M and the distance from the LiDAR to the planar surface P, which are measured by using the LiDAR (Light Detection Ranging).

### (Configuration of Designation Device)

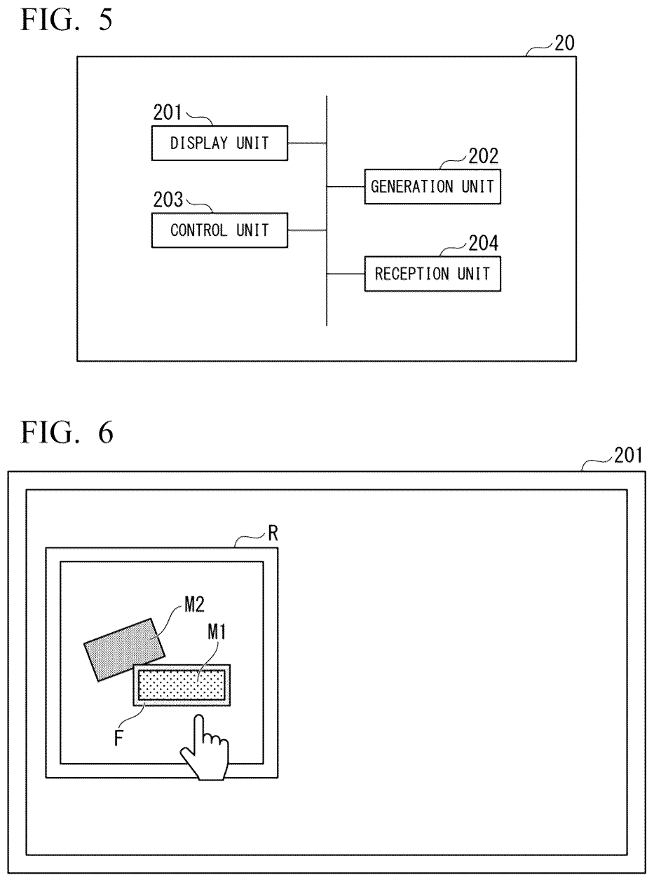

FIG. 5 is a diagram illustrating an example of the configuration of the designation device 20 according to a first example embodiment of the present disclosure. The designation device 20, as shown in FIG. 5, includes a display unit 201 (an example of a display device), a generation unit 202, a control unit 203 (an example of control means), and a reception unit 204 (an example of reception means). The designation device 20 is, for example, a tablet terminal having touch panel functions.

The display unit 201, under control implemented by the control unit 203, displays a two-dimensional image captured by the camera 101 and an image indicating the external form F of an object M to be moved, to be described below, input from the reception unit 204. The external form F is displayed only for an object M that is to be grasped among one or a plurality of objects M to be moved. FIG. 6 is a diagram illustrating an example of an image displayed by the display unit 201 according to the first example embodiment of the present disclosure. In the example shown in FIG. 6, as the objects M to be moved, the objects M1 and M2, and the external form F of the object M1, are illustrated. Additionally, in the example shown in FIG. 6, the region R is illustrated. The hand shown in FIG. 6 is not displayed by the display unit 201, and is shown to illustrate the case in which a worker has performed operations with a finger on the touch panel to indicate the external form F.

The generation unit 202 generates a control signal Cnt1 for making the display unit 201 display a two-dimensional image, as well as the external form F of the object M to be moved, based on information on the two-dimensional images captured by the camera 101 and a signal indicating the external form F of the object M to be moved, generated by the reception unit 204 in accordance with operations performed by the worker generating the external form F of the object to be moved, to be described below. In the present disclosure, “performing ZZ on XX as well as YY” includes both executing the process of ZZ simultaneously on XX and YY, and executing the process of ZZ separately on XX and YY. For example, “displaying XX as well as YY” includes executing a process to display XX and YY simultaneously. Additionally, “displaying XX as well as YY” includes executing a process to display XX, then executing a process to display YY, and executing a process to display YY, then executing a process to display XX. The “XX” and the “YY” are arbitrary elements (e.g., arbitrary information). Additionally, “ZZ” is an arbitrary process. Additionally, while the two arbitrary elements “XX” and “YY” were indicated as examples, if there are three or more arbitrary elements, cases in which the process of ZZ is executed simultaneously, separately, and simultaneously for some of the elements and separately for the remaining elements are included.

In a case where the lines indicating the external form F of an object to be moved by operations performed by the worker to generate the external form F of the object to be moved are not straight lines, the generation unit 202 may straighten the lines. In a case where the generation unit 202 straightens the lines indicating the external form F, the generation unit 202 generates, as the control signal Cnt1, a control signal for displaying the external form F with the straightened lines. As a result thereof, the external form F of the object M to be moved displayed on the display unit 201 by the control unit 203 is also displayed with straight lines. However, in a case where the lines have been straightened, the external form F displayed on the display unit 201 will not necessarily be matched with the actual external form of the object M to be moved. In a case where the external forms are not matched, the worker may change the inclinations of the lines indicating the external form F displayed on the display unit 201 and perform, on the reception unit 204, operations to match the external form F with the actual external form of the object M to be moved displayed on the display unit 201. Due to these operations, the reception unit 204 generates a signal in accordance with the operations. The generation unit 202 generates a control signal Cnt1 for matching the external form F with the actual external form of the object M to be moved based on the signal generated by the reception unit 204.

The control unit 203 makes the display unit 201 display the two-dimensional image captured by the camera 101, as well as the external form F of the object M to be moved input from the reception unit 204, based on the control signal Cnt1 generated by the generation unit 202.

In a case where the reception unit 204 has not generated a signal indicating the external form F of an object M to be moved, and the camera 101 is capturing two-dimensional images, the generation unit 202 generates a control signal Cnt1 for making the display unit 201 display a two-dimensional image captured by the camera 101. In this case, the control unit 203 makes the display unit 201 display the two-dimensional image captured by the camera 101 based on the control signal Cnt1 generated by the generation unit 202.

The reception unit 204 receives inputs, by the worker, designating at least a portion of the external form of an object to be moved. For example, the reception unit 204 is a touch panel that receives operations, by a finger of the worker, by a pen for use exclusively with the touch panel, and the like, to generate the external form of an object to be moved. Examples of operations to generate the external form of an object to be moved include operations to trace the external form of an object to be moved with a finger or a pen, operations to designate vertexes of an object to be moved with a finger or a pen, and the like. In a case where a worker has performed operations to designate vertexes of an object to be moved with a finger or a pen on the reception unit 204, the generation unit 202 may, for example, generate a control signal Cnt1 to display lines obtained by connecting two designated vertexes with a straight line each time the worker designates two vertexes, and the control unit 203 may control the display on the display unit 201 based on the control signal Cnt1 generated by the generation unit 202. Due to this control signal Cnt1, the control unit 203 can make the display unit 201 display the external form F of an object M to be moved.

The reception unit 204 receives inputs of work goals. Examples of work goals include information including the types of the objects M to be moved, the number of these objects, the movement destinations of these objects, and the like. The reception unit 204 receives, as a work goal, for example, the input, “move three of the components A to a tray”. In this case, the reception unit 204 may identify the work goal by determining that the type of the objects M to be moved is the components A, that the number of the objects is three, and that the movement destination of the objects is the tray. The reception unit 204 transmits the received work goal to the control device 30.

### (Configuration of Control Device)

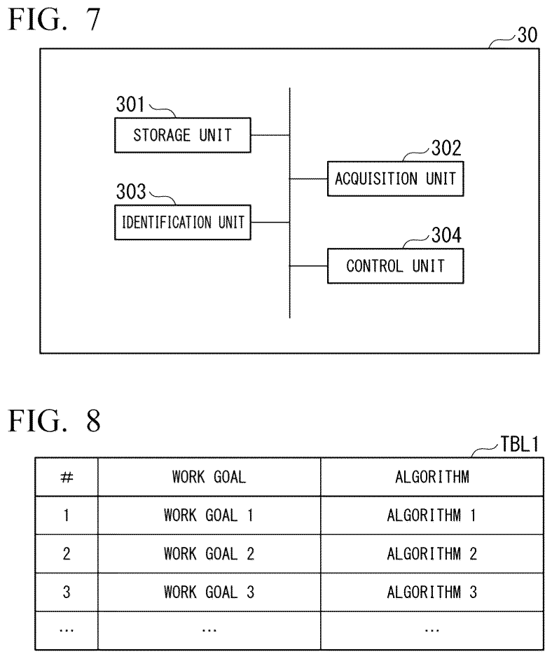

The control device 30 is a device that, upon receiving information indicating the work goal and information indicating the pre-movement states (i.e., the positions and postures) of the objects M to be moved, makes the robot 40 grasp the objects M in accordance with the received pre-movement states of the objects M to be moved and, based on a predetermined algorithm in accordance with the received work goal, makes the robot 40 execute a process based on the predetermined algorithm (i.e., a process for moving the grasped objects M to the predetermined movement destination). FIG. 7 is a diagram illustrating an example of the configuration of the control device 30 according to the first example embodiment of the present disclosure. The control device 30, as shown in FIG. 7, includes a storage unit 301, an acquisition unit 302, an identification unit 303, and a control unit 304.

The storage unit 301 stores various types of information necessary for the processes performed by the control device 30. Examples of information stored in the storage unit 301 include a data table TBL1, and the like indicating correspondence relationships between work goals and algorithms that is to be used in a case where the identification unit 303, to be described below, is to identify an algorithm in accordance with a work goal. FIG. 8 is a diagram illustrating an example of a data table TBL1 stored by the storage unit 301 according to the first example embodiment of the present disclosure. The storage unit 301, as shown in FIG. 8, stores work goals and algorithms, in an associated manner, as the data table TBL1.

The acquisition unit 302 acquires information indicating the pre-movement states of objects to be moved. Specifically, the acquisition unit 302 receives, from the measurement device 10, information indicating measurement results measured by the camera 102, i.e., the heights of the objects M to be moved from the planar surface P. Additionally, the acquisition unit 302 receives, from the designation device 20, information indicating the external form F of an object M to be moved. The acquisition unit 302 can identify the shapes of the objects M to be moved from the received information indicating the heights of the objects M to be moved from the planar surface P and the received information indicating the external form F of an object M to be moved.

Additionally, the acquisition unit 302 receives, from the designation device 20, information indicating the work goal (i.e., information indicating the types of the objects to be moved, the number of these objects, and the movement destinations of these objects).

The identification unit 303 identifies an algorithm to be used to move the objects to be moved to the movement destinations based on the work goal received by the acquisition unit 302. For example, in a case where the work goal received by the acquisition unit 302 is a work goal 1, the identification unit 303 identifies the work goal 1 from among the work goals in the data table TBL1 stored in the storage unit 301. Then, the identification unit 303 identifies an algorithm 1 associated with the identified work goal 1 in the data table TBL1.

The control unit 304 controls the robot 40 by transmitting, to the robot 40, a control signal Cnt2 in accordance with the algorithm identified by the identification unit 303. The control signal Cnt2 is a control signal for making the robot 40 grasp the objects M to be moved and move the grasped objects M to movement destinations designated by the worker. The control signal Cnt2 may be prepared in advance for each of the algorithms in the data table TBL1, or may be generated by the control unit 304 in response to each algorithm identified by the identification unit 303.

### (Configuration of Robot)

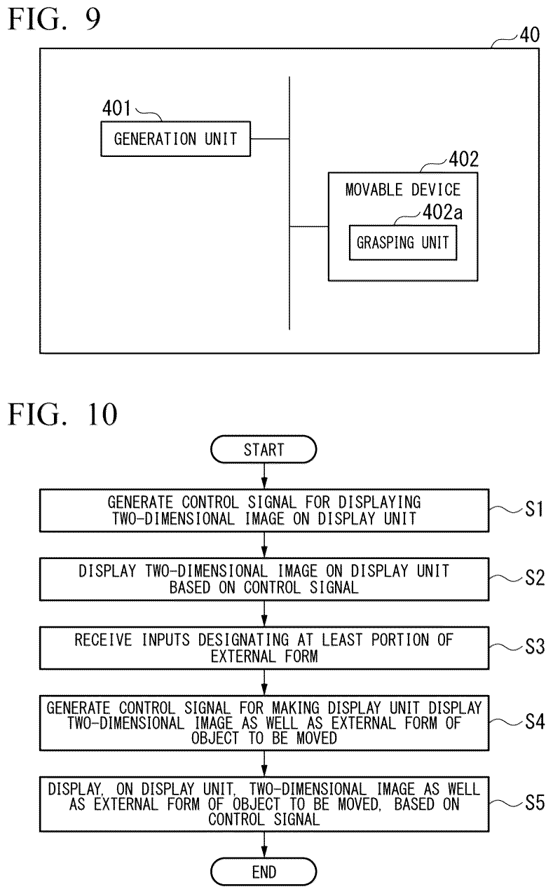

The robot 40 is a robot that, based on the control signal Cnt2 received from the control device 30, grasps the objects M to be moved and that moves the objects M to movement destinations input to the designation device 20 by a worker. The process of the robot 40 moving the objects M to the movement destinations is continued until the number of objects designated by the work goal are moved to the movement destinations. Examples of the robot 40 include vertically articulated robots, horizontally articulated robots, and other arbitrary types of robots. FIG. 9 is a diagram illustrating an example of the configuration of the robot 40 according to a first example embodiment of the present disclosure. The robot 40, as shown in FIG. 9, includes a generation unit 401 and a movable device 402.

The generation unit 401 receives the control signal Cnt2 from the control device 30. The generation unit 401 generates drive signals Dry for operating the movable device 402 (i.e., for making the movable device 402 grasp the objects M to be moved and move the objects M to the movement destinations) based on the received control signal Cnt2. The generation unit 401, in a case where the objects M to be moved are to be grasped by a grasping unit 402a, to be described below, for example, generates a control signal Cnt2 such that the grasping unit 402a approaches an object M from a direction perpendicular against the position of the centroid of the surface indicating the external form F of the object M to be moved (in the first example embodiment, directly above the object M, since the object M to be moved is placed parallel to the planar surface P).

The movable device 402, as shown in FIG. 9, includes a grasping unit 402a. The grasping unit 402a includes mechanisms for grasping objects M to be moved. Examples of mechanisms for grasping objects M to be moved include mechanisms for pinching the objects M between a plurality of (for example, two) fingers, mechanisms for suctioning predetermined surfaces of the objects M, and the like. Examples of the predetermined surfaces include the surface with the largest area among a plurality of surfaces of an object M to be moved included in the images captured by the camera 101, the surface that is the closest to parallel to the planar surface P among a plurality of surfaces of an object M to be moved, and the like. The movable device 402 is a device that grasps the objects M to be moved by means of the grasping unit 402a and that moves the objects M to movement destinations based on the drive signals Drv generated by the generation unit 401. For example, the movable device 402 is a robot arm including a stepping motor. In a case where the movable device 402 is a robot arm including a stepping motor, the movable device 402 makes the grasping unit 402a grasp the objects M to be moved and move the objects M to the movement destinations by operating the stepping motor in accordance with the drive signals Dry generated by the generation unit 401.

### (Process Performed by Robot System)

FIG. 10 is a diagram illustrating an example of the processing flow in the robot system 1 according to the first example embodiment of the present disclosure. Next, the process performed by the robot system 1 will be explained with reference to FIG. 10.

The camera 101 captures two-dimensional images including a portion of the planar surface P and the objects M to be moved, which are placed on the planar surface P. The camera 101 transmits information regarding the captured images to the designation device 20 via the network NW.

At this time, the reception unit 204 has not generated a signal indicating the external form F of an object M to be moved. Therefore, the generation unit 202 generates a control signal Cnt1 for making the display unit 201 display a two-dimensional image captured by the camera 101 (step S1). Furthermore, the control unit 203 makes the display unit 201 display the two-dimensional image captured by the camera 101 based on the control signal Cnt1 generated by the generation unit 202 (step S2). The display unit 201 displays the two-dimensional image captured by the camera 101.

The camera 102 measures the height in the Z-axis direction, relative to the XY plane, of the object M to be moved by defining the planar surface P to be the region at the furthest distance from the camera 102 within an error range that is more than the machining precision of the planar surface P and less than or equal to the size of the object M, in the image capture region, and by calculating the difference between the distance from the camera 102 to the object to be moved in a designated region of the object M to be moved and the distance from the camera 102 to the planar surface P. The camera 102 transmits information indicating the measurement results (i.e., information indicating the height of the object M) to the control device 30 via the network NW.

In this case, suppose that the reception unit 204 has received an input by a worker designating at least a portion of the external form of an object to be moved (step S3). For example, the reception unit 204 is a touch panel that receives operations for generating the external form of an object to be moved by means of a finger of the worker, a pen for use exclusively with the touch panel, and the like.

The generation unit 202 generates a control signal Cnt1 for making the display unit 201 display a two-dimensional image, as well as the external form F of the object M to be moved, based on information on the two-dimensional images captured by the camera 101 and a signal indicating the external form F of the object M to be moved, generated by the reception unit 204 in accordance with the operations performed by the worker for generating the external form F of the object M to be moved (step S4).

The control unit 203 makes the display unit 201 display the two-dimensional image captured by the camera 101, as well as the external form F of the object M to be moved, input from the reception unit 204, based on the control signal Cnt1 generated by the generation unit 202 (step S5). The display unit 201 displays the two-dimensional image captured by the camera 101, as well as the external form F of the object M to be moved, input from the reception unit 204.

In a case where the lines indicating the external form F of an object to be moved by operations performed by the worker to generate the external form F of the object to be moved are not straight lines, the generation unit 202 may straighten the lines. In a case where the generation unit 202 has straightened the lines indicating the external form F, the generation unit 202 generates the control signal Cnt1 for displaying the external form F with straightened lines. The control unit 203 makes the display unit 201 display the two-dimensional image captured by the camera 101, as well as the external form F of the object M to be moved, with straightened lines, based on the control signal Cnt1 generated by the generation unit 202. The display unit 201 displays the two-dimensional image captured by the camera 101, as well as the external form F of the object M to be moved, with straightened lines.

In this case, suppose that the reception unit 204 has received an input of a work goal. The reception unit 204 transmits the received work goal to the control device 30.

The acquisition unit 302 acquires information indicating the pre-movement states of objects to be moved. Specifically, the acquisition unit 302 receives, from the measurement device 10, measurement results measured by the camera 102, i.e., information indicating the heights of the objects M to be moved from the planar surface P. The acquisition unit 302 receives, from the designation device 20, information indicating the external form F of an object M to be moved. The acquisition unit 302 receives, from the designation device 20, information indicating the work goal (i.e., information indicating the types of the objects to be moved, the number of these objects, and the movement destinations of these objects).

The identification unit 303 identifies an algorithm to be used to move the objects to be moved to the movement destinations based on the work goal received by the acquisition unit 302. For example, in a case where the work goal received by the acquisition unit 302 is a work goal 1, the identification unit 303 identifies the work goal 1 from among the work goals in the data table TBL1 stored in the storage unit 301. Then, the identification unit 303 identifies an algorithm 1 associated with the identified work goal 1 in the data table TBL1.

The control unit 304 controls the robot 40 by transmitting, to the robot 40, a control signal Cnt2 in accordance with the algorithm identified by the identification unit 303. The control signal Cnt2 is a control signal for making the robot 40 grasp the objects M to be moved and move the grasped objects M to the movement destinations designated by the worker. The control signal Cnt2 may be prepared in advance for each of the algorithms in the data table TBL1, or may be generated by the control unit 304 in response to each algorithm identified by the identification unit 303. A contact sensor may be provided at the tip of the grasping unit 402a, and the control unit 304 may stop the movement of the grasping unit 402a towards an object M in a case where the contact sensor has detected contact with the object M.

### (Advantages)

The robot system 1 according to the first example embodiment of the present disclosure has been explained above. In the designation device 20 of the robot system 1, the reception unit 204 receives inputs designating the external form F of an object M to be moved. The control unit 203 makes the display unit 201 (an example of a display device) display the two-dimensional image including the objects M to be moved, as well as the designated external form F.

By doing so, the designation device 20 displays the external form F of an object M to be moved, designated by the worker via the reception unit 204, as well as the two-dimensional image including the objects M to be moved. Therefore, in a case where the worker uses the designation device 20, the worker can designate the position of the external form F of an object M to be moved while checking the positional relationship between the two-dimensional image including the objects M and the external form F of an object M to be moved, designated by the worker. Additionally, since the image displayed by the designation device 20 is two-dimensional, and the worker merely needs to match the external form F with an object M in that image, and the worker can therefore easily perform the operations for designating the external form F. Thus, due to the designation device 20, in a robot system that, in a case where the pre-movement state of an object is input, moves the object by following a predetermined algorithm in accordance with a work goal, a worker can easily designate the state of the object. As a result thereof, even if the robot system cannot correctly recognize an object, the object can be made correctly recognizable.

In robot systems that, in a case where the pre-movement state of an object is input, moves that object by following a predetermined algorithm in accordance with a work goal, the features indicated below are desirable. Namely, it is desirable to be able to input, to a robot, the correct pre-movement state of an object or a desired post-movement state of an object by a worker designating the pre-movement state of the object or the post-movement state of the object determined by an algorithm. Additionally, it is desirable for a worker to be able to easily designate the pre-movement or post-movement state of the object. In the robot system 1 according to a modified example of the first example embodiment of the present disclosure, the state of the object can be easily designated by the worker. As a result thereof, even in a case where the robot system cannot correctly recognize an object, the object can be made correctly recognizable.

### Modified Example of First Example Embodiment

Next, a robot system 1 according to a modified example of the first example embodiment of the present disclosure will be explained. The robot system 1 according to the modified example of the first example embodiment, like the robot system 1 according to the first example embodiment shown in FIG. 1, includes a measurement device 10, a designation device 20, a control device 30, and a robot 40.

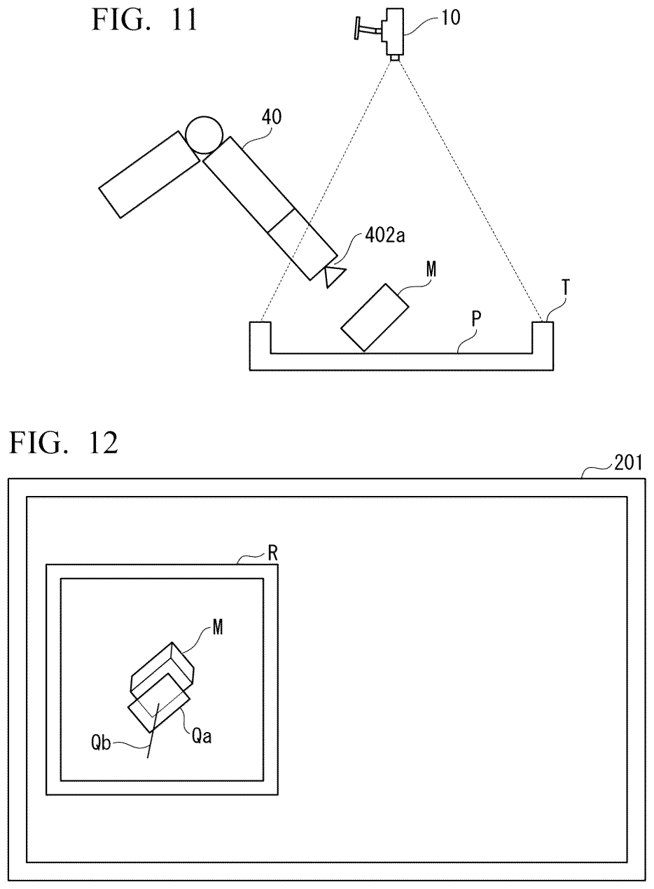

FIG. 11 is a diagram illustrating an example of installation of the measurement device 10 according to the modified example of the first example embodiment of the present disclosure. As shown in FIG. 11, the measurement device 10 is provided at a fixed position from which an image of a planar surface P of a tray T on which objects M to be moved are placed can be captured from above. In the first example embodiment, the objects to be moved are assumed to be objects placed on and parallel to the planar surface P, which is oriented substantially horizontally. However, in the modified example of the first example embodiment, the objects to be moved are assumed to be objects placed at an incline (i.e., having an inclination) with respect to the planar surface P that is oriented substantially horizontally. Thus, the first example embodiment and the modified example of the first example embodiment mainly differ in terms of the processes performed by the designation device 20. In this case, the processes that are different between the designation device 20 according to the modified example of the first example embodiment and the designation device 20 according to the first example embodiment will be mainly explained. Processes that are not particularly explained should be considered to be similar to those in the first example embodiment, taking into consideration that the external form F displayed on the display unit 201 is replaced by a surface Qa and an axis Qb forming a predetermined angle with respect to that surface Qa, and that the objects M, which were placed parallel to the planar surface P, are placed at an incline.

The designation device 20 according to the modified example of the first example embodiment, like the designation device 20 according to the first example embodiment shown in FIG. 5, includes a display unit 201 (an example of a display device), a generation unit 202, a control unit 203, and a reception unit 204.

The display unit 201, under control implemented by the control unit 203, displays a two-dimensional image captured by the camera 101, and an image indicating a surface Qa that is assumed to be a predetermined surface of an object M to be moved, and an axis Qb forming a predetermined angle with respect to the surface Qa, input from the reception unit 204. The surface Qa and the axis Qb forming a predetermined angle with respect to that surface Qa are displayed only with respect to an object M to be grasped among the objects M to be moved. FIG. 12 is a diagram illustrating an example of an image displayed by the display unit 201 according to the modified example of the first example embodiment of the present disclosure. In the example shown in FIG. 12, an object M to be moved, a surface Qa, and an axis Qb forming a predetermined angle with respect to that surface Qa are shown. Additionally, in the example shown in FIG. 12, a region R is shown. Under the control implemented by the control unit 203, the shape of the surface Qa displayed on the display unit 201 may change (using perspective) in accordance with the angle designating the axis Qb (for example, displaying the profile of an inclined rectangle on a two-dimensional screen (for example, in a case where the predetermined surface of the object M is rectangular, a profile indicating a parallelogram or a trapezoid in accordance with the angle designating the axis Qb)). As a result thereof, even in a bird's-eye view of the object M from above (i.e., from the positive Z-axis direction), the planar surface Qa can easily be matched with the predetermined surface of the object M. As a result thereof, even in a case where the robot system cannot correctly recognize an object, the object can be made correctly recognizable.

Data for displaying information of a two-dimensional image captured by the camera 101, the surface Qa, and the axis Qb forming a predetermined angle with respect to the surface Qa are prepared in advance. Based on a signal indicating the surface Qa and the axis Qb forming a predetermined angle with respect to the surface Qa generated in accordance with operations performed by a worker to match the surface Qa with a predetermined surface of an object M to be moved, to be described below, the generation unit 202 generates a control signal Cnt1 for making the display unit 201 display the two-dimensional image, as well as the surface Qa and the axis Qb forming a predetermined angle with respect to the surface Qa.

The control unit 203 makes the display unit 201 display the two-dimensional image captured by the camera 101, as well as the surface Qa and the axis Qb forming a predetermined angle with respect to the surface Qa, input from the reception unit 204, based on the control signal Cnt1 generated by the generation unit 202.

Unlike the first example embodiment, in which there are states in which a signal indicating the external form F of an object M to be moved is not generated, the reception unit 204 generates a signal indicating the surface Qa and the axis Qb forming a predetermined angle with respect to the surface Qa. For this reason, the control unit 203 makes the display unit 201 display the two-dimensional image captured by the camera 101, as well as the surface Qa and the axis Qb forming a predetermined angle with respect to the surface Qa, based on the control signal Cnt1 generated by the generation unit 202.

The reception unit 204 receives inputs by a worker for operating the surface Qa designating the predetermined surface of the object M. For example, in a case where the angle formed between the surface Qa and the axis Qb is 90 degrees, a worker first performs operations on a touch panel, using a finger, a pen for use exclusively with the touch panel, or the like, to match the axis Qb with a direction in which the grasping unit 402a is to approach an object M. The reception unit 204 receives these operations by the worker. Due to the operations by the worker to match the axis Qb with the direction in which the grasping unit 402a is to approach the object M to be moved, the predetermined surface of the object M to be moved is made parallel with the surface Qa. Next, the worker performs operations to match the surface Qa with the predetermined surface of the object M to be moved, by moving the surface Qa along the axis Qb in parallel. The reception unit 204 receives these operations by the worker. In fact, the reception unit 204 may receive operations by the worker from moment to moment. Each time the reception unit 204 receives an operation by the worker, the generation unit 202 generates a control signal Cnt1. Furthermore, the control unit 203 controls the display on the display unit 201 based on the control signal Cnt1 generated by the generation unit 202.

### (Advantages)

The robot system 1 according to the modified example of the first example embodiment of the present disclosure has been explained above. In the designation device 20 of the robot system 1, the reception unit 204 receives inputs of a surface Qa designating a predetermined surface of an object M to be moved. The control unit 203 makes the display device display the two-dimensional image including the object M to be moved, as well as the surface Qa received by the reception unit 204.

By doing so, the designation device 20 displays a two-dimensional image including the predetermined surface of an object M to be moved, as well as the surface Qa designating the predetermined surface. Therefore, in a case where the worker uses the designation device 20, the worker can match the surface Qa with the predetermined surface of an object M to be moved while checking the positional relationship between the two-dimensional image including the predetermined surfaces of the objects M and the surface Qa. Since the image displayed by the designation device 20 is two-dimensional, the worker merely needs to match the surface Qa with the predetermined surface of an object M in that image. Additionally, since the axis Qb forming a predetermined angle with respect to the surface Qa is also displayed, the axis Qb serves as a guide for adjustment. For this reason, the worker can easily operate the surface Qa. Thus, due to the designation device 20, in a robot system that, in a case where the pre-movement state of an object is input, moves that object by following a predetermined algorithm in accordance with a work goal, a worker can easily designate the state of the object. As a result thereof, even if the robot system cannot correctly recognize an object, the object can be made correctly recognizable.

If a predetermined surface of an object M to be moved is defined, the control of the grasping unit 402a by the control device 30 causes the grasping unit 402a to approach that surface confronting directly. For this reason, whether the grasping mechanism included in the grasping unit 402a is a mechanism for pinching the objects M between a plurality of (for example, two) fingers, or is a mechanism for suctioning the predetermined surfaces of the objects M, the grasping unit 402a can appropriately grasp the objects M.

### Second Example Embodiment

Next, a robot system 1 according to a second example embodiment of the present disclosure will be explained. FIG. 13 is a diagram illustrating an example of the configuration of the robot system 1 according to the second example embodiment of the present disclosure. The robot system 1 according to the second example embodiment, as shown in FIG. 13, includes a measurement device 10, a designation device 20, a control device 30, and a robot 40, like the robot system 1 according to the first example embodiment shown in FIG. 1, and further includes an automatic recognition system 50. In the second example embodiment, as in the first example embodiment, objects M to be moved are placed on and parallel to a planar surface P that is oriented substantially horizontally. In this case, the processes that are different between the robot system 1 according to the second example embodiment and the robot system 1 according to the first example embodiment will be mainly explained.

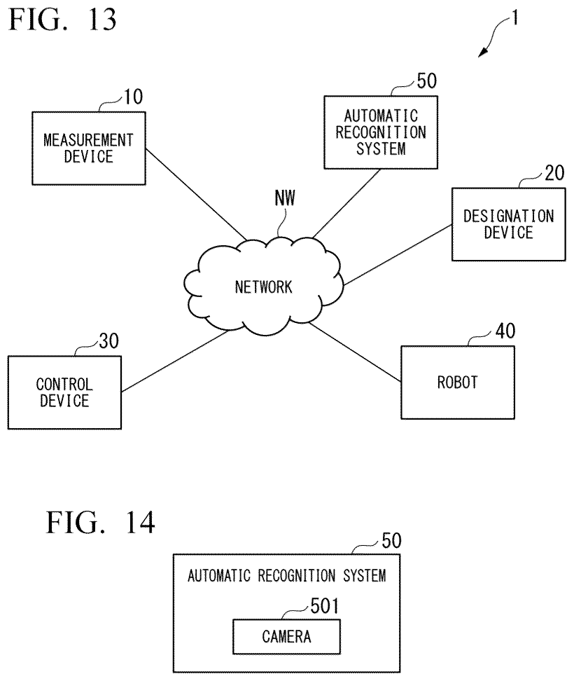

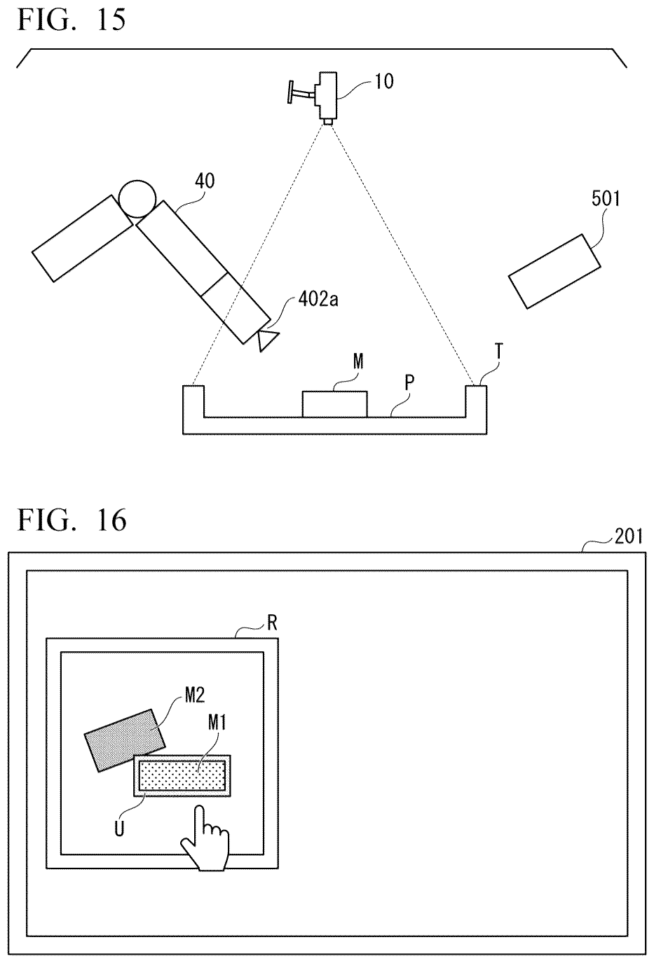

The automatic recognition system 50 is a system that captures images of objects M to be moved and that can identify the states (i.e., the positions and postures) of the objects M to be moved. FIG. 14 is a diagram illustrating an example of the configuration of the automatic recognition system 50 according to the second example embodiment of the present disclosure. The automatic recognition system 50 includes a camera 501, as shown in FIG. 14. The camera 501 is an industrial camera. The automatic recognition system 50 identifies the shape of the upper surface of an object M and the height of the object M from a planar surface P by capturing images of objects M by means of the camera 501. That is, the automatic recognition system 50, like the measurement device 10, can identify the shape of the upper surface of an object M and the height of the object M from the planar surface P. The automatic recognition system 50 transmits the identified information regarding the shape of the upper surface of the object M and the height of the object M from the planar surface P to a designation device 20 and a control device 30. FIG. 15 is a diagram illustrating an example of installation of the camera 501 according to the second example embodiment of the present disclosure. As shown in FIG. 15, the camera 501, for example, captures images of the objects M to be moved from a direction different from the measurement device 10. This automatic recognition system 50 may be realized by using existing technology.

The control device 30, like the control device 30 according to the first example embodiment shown in FIG. 7, includes an acquisition unit 302, an identification unit 303, and a control unit 304. However, the control device 30 receives information of the shape of the upper surface of an object M and the height of the object M from the planar surface P. The received information is information from the automatic recognition system 50 similar to the external form of an object M and the height of the object M from the planar surface P received from the measurement device 10 and the designation device 20. Furthermore, the control device 30, unlike the control device 30 according to the first example embodiment, normally generates a control signal Cnt2 based on the information regarding the shape of the upper surface of an object M and the height of the object M from the planar surface P received from the automatic recognition system 50. The respective processes in the acquisition unit 302, the identification unit 303, and the control unit 304 can be contemplated by replacing the information regarding the external form of an object M and the height of the object M from the planar surface P in the processes explained regarding the acquisition unit 302, the identification unit 303, and the control unit 304 according to the first example embodiment with the information regarding the shape of the upper surface of an object M and the height of the object M from the planar surface P received from the automatic recognition system 50.

Next, the designation device 20 will be explained. The explanation below pertains to the process performed by the designation device 20 in a case where the control device 30 cannot appropriately control the robot 40 in a case where the control device 30 uses information regarding the shape of the upper surface of an object M and the height of the object M from the planar surface P received from the automatic recognition system 50.

The designation device 20, like the designation device 20 according to the first example embodiment shown in FIG. 5, includes a display unit 201, a generation unit 202, a control unit 203, and a reception unit 204.

The generation unit 202 generates a control signal Cnt1 for making the display unit 201 display a two-dimensional image, as well as the shape U (corresponding to the external form F in the first example embodiment) of the upper surface of an object M to be moved, based on information on the two-dimensional images captured by the camera 101 and the information regarding the shape of the upper surface of an object M and the height of the object M from the planar surface P received from the automatic recognition system 50.

The control unit 203 makes the display unit 201 display the two-dimensional image captured by the camera 101, as well as the shape U of the upper surface of an object M to be moved, based on the control signal Cnt1 generated by the generation unit 202.

The reception unit 204 receives inputs by a worker designating (in this case, designating by changing) the shape U of the upper surface of an object M to be moved. For example, the reception unit 204 is a touch panel that receives operations, by a finger of the worker, by a pen for use exclusively with the touch panel, and the like, to select the shape U of the upper surface of an object M to be moved, and to move the selected shape U to a desired position (i.e., a position on the upper surface of the actual object M to be moved, appearing in the two-dimensional image).

Even while the worker is performing the operations to move the selected shape U to the desired position, the generation unit 202 generates the control signal Cnt1 in accordance with the operations. Furthermore, during this time, the control unit 203 makes the display unit 201 display the two-dimensional image captured by the camera 101, as well as the shape U of the upper surface of an object M to be moved, based on the control signal Cnt1 generated by the generation unit 202. As a result thereof, the display unit 201, under control implemented by the control unit 203, displays the two-dimensional image captured by the camera 101, as well as the shape U. FIG. 16 is a diagram illustrating an example of an image displayed by the display unit 201 according to the second example embodiment of the present disclosure. In the example shown in FIG. 16, as the objects M to be moved, the objects M1 and M2, and the shape U of the upper surface of the object M1 are shown. Additionally, in the example shown in FIG. 16, the region R is shown. The hand shown in FIG. 16 is not displayed by the display unit 201, and is shown to illustrate an image of the case in which a worker has performed operations with a finger on a touch panel to move the shape U and to indicate the position of the shape U.

### (Advantages)

The robot system 1 according to the second example embodiment of the present disclosure has been explained above. In the designation device 20 of the robot system 1, the reception unit 204 receives inputs for moving the position of the shape U of the upper surface of an object M to be moved, which is displayed on the display unit 201 based on the state of the object M to be moved identified by the automatic recognition system 50 including the camera 501. The generation unit 202 changes the control signal Cnt1 based on the inputs for moving the position of the shape U received by the reception unit 204. The control unit 203 makes the display unit 201 display the two-dimensional image captured by the camera 101, as well as the shape U of the upper surface of the object M to be moved, based on the control signal Cnt1.

By doing so, the designation device 20 displays the shape U of the upper surface of an object M to be moved, designated by the worker via the reception unit 204, as well as the two-dimensional image including the objects M to be moved. Therefore, in a case where the worker uses the designation device 20, the worker can designate the position of the shape U of the upper surface of an object M to be moved while checking the positional relationship between the two-dimensional image including the objects M and the shape U of the upper surface of an object M to be moved, designated by the worker. Additionally, since the image displayed by the designation device 20 is two-dimensional, the worker merely needs to move the shape U of the upper surface of an object M to be moved to a desired position in the image. For this reason, the operations for the worker to designate the shape U can be easily performed. Thus, due to the designation device 20, in a robot system that, in a case where the pre-movement state of an object is input, moves that object by following a predetermined algorithm in accordance with a work goal, a worker can easily designate the state of the object. As a result thereof, even if the robot system cannot correctly recognize an object, the object can be made correctly recognizable.

### Modified Example of Second Example Embodiment

Next, a robot system 1 according to a modified example of the second example embodiment of the present disclosure will be explained. The robot system 1 according to the modified example of the second example embodiment, like the robot system 1 according to the second example embodiment shown in FIG. 13, includes a measurement device 10, a designation device 20, a control device 30, a robot 40, and an automatic recognition system 50. In the modified example of the second example embodiment, like the modified example of the first example embodiment, the objects M to be moved are assumed to be placed at an incline with respect to the planar surface P.

In the same manner that the external form F of an object M to be moved in the robot system 1 according to the first example embodiment 1 was replaced with the shape U of the upper surface of an object M to be moved in the robot system 1 according to the second example embodiment, the robot system 1 according to the modified example of the second example embodiment can be contemplated by replacing the surface Qa and the axis Qb forming a predetermined angle with respect to the surface Qa in the modified example of the second example embodiment with a surface Va and an axis Vb forming a predetermined angle with respect to the surface Va (corresponding to the surface Qa and the axis Qb forming a predetermined angle with respect to the surface Qa), generated by the automatic recognition system 50, the processes being executed by combining the processes of the robot systems 1 in the modified example of the first example embodiment and the second example embodiment. For example, in a case where a surface Va generated by the automatic recognition system 50 differs from an expected surface, a worker may designate a surface Qa by performing operations on a touch panel with a finger to designate a predetermined surface of an object M and to set an axis Qb, thereby correcting the axis Vb.

Data for displaying two-dimensional image information captured by the camera 101, the surface Va generated by the automatic recognition system 50, and the axis Vb forming a predetermined angle with respect to the surface Va is prepared in advance. The generation unit 202 generates a control signal Cnt1 for making the display unit 201 display the two-dimensional image, as well as the surface Va and the axis Vb forming a predetermined angle with respect to the surface Va, based on a signal indicating the surface Va and the axis Vb forming a predetermined angle with respect to the surface Va generated in accordance with operations performed by a worker to match the surface Va with the predetermined surface of an object M to be moved.

The control unit 203 makes the display unit 201 display the two-dimensional image captured by the camera 101, as well as the surface Va and the axis Vb forming a predetermined angle with respect to the surface Va, based on the control signal Cnt1 generated by the generation unit 202.

The reception unit 204 receives the operations that were performed by a worker with respect to the surface Va and the axis Vb forming a predetermined angle with respect to the surface Va, and that is like operations performed with respect to the surface Qa and the axis Qb forming a predetermined angle with respect to the surface Qa, explained in the modified example of the first example embodiment.

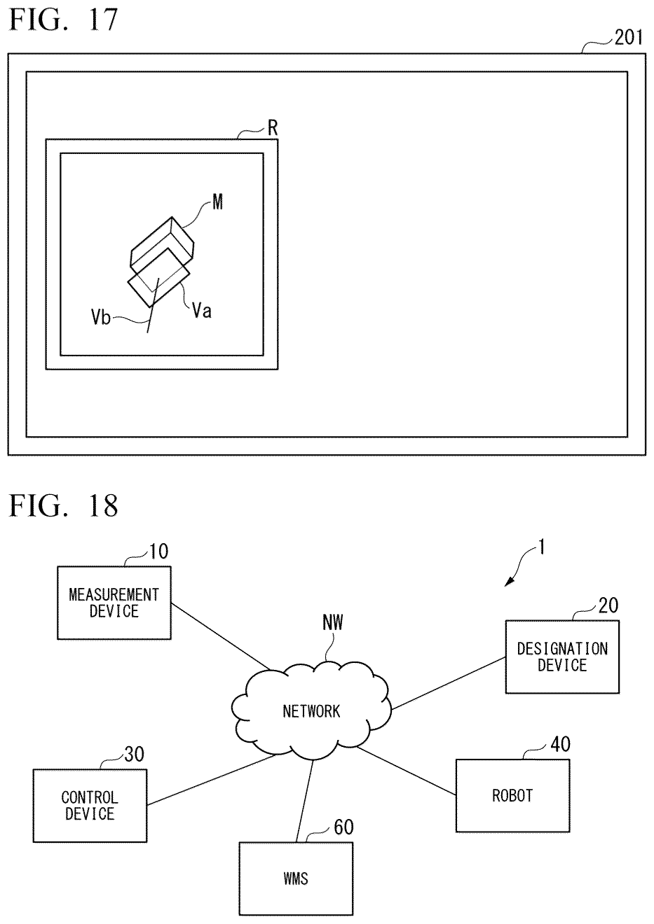

Even while the worker is performing the operations to move the surface Va to a predetermined position, the generation unit 202 is generating a control signal Cnt1 in accordance with those operations. During this time, the control unit 203 makes the display unit 201 display the two-dimensional image captured by the camera 101, as well as the surface Va and the axis Vb forming a predetermined angle with respect to the surface Va, based on the control signal Cnt1 generated by the generation unit 202. As a result thereof, the display unit 201, under control implemented by the control unit 203, displays the two-dimensional image captured by the camera 101, as well as the surface Va and the axis Vb forming a predetermined angle with respect to the surface Va. FIG. 17 is a diagram illustrating an example of an image displayed by the display unit 201 according to the modified example of the second example embodiment of the present disclosure. In the example shown in FIG. 17, the object M to be moved, the surface Va, and the axis Vb forming a predetermined angle with respect to the surface Va are shown. Additionally, in the example shown in FIG. 17, the region R is shown.

### (Advantages)

The robot system 1 according to the modified example of the second example embodiment of the present disclosure has been explained above. In the designation device 20 of the robot system 1, the reception unit 204 receives the operations that were performed by a worker with respect to the surface Va and the axis Vb forming a predetermined angle with respect to the surface Va, and that is like operations performed with respect to the surface Qa and the axis Qb forming a predetermined angle with respect to the surface Qa, explained in the modified example of the first example embodiment. The generation unit 202 generates a control signal Cnt1 in accordance with the operations received by the reception unit 204. The control unit 203 makes the display device 201 display the two-dimensional image captured by the camera 101, as well as the surface Va and the axis Vb forming a predetermined angle with respect to the surface Va, based on the control signal Cnt1 generated by the generation unit 202.

By doing so, the designation device 20 displays a two-dimensional image including the predetermined surface of an object M to be moved, as well as the surface Va designating the predetermined surface, designated by the worker via the reception unit 204. Therefore, in a case where the worker uses the designation device 20, the worker can match the surface Va with the predetermined surface of the object M to be moved while checking the positional relationship between the two-dimensional image including the predetermined surface of the object M and the surface Va. Since the image displayed by the designation device 20 is two-dimensional, the worker merely needs to match the surface Va with the predetermined surface of the object M in that image. Additionally, since the axis Vb forming a predetermined angle with respect to the surface Va is also displayed, the axis Vb serves as a guide for adjustment. For this reason, the worker can easily perform operations on the surface Va. Thus, due to the designation device 20, in a robot system that, in a case where the pre-movement state of an object is input, moves that object by following a predetermined algorithm in accordance with a work goal, a worker can easily designate the state of the object. As a result thereof, even if the robot system cannot correctly recognize an object, the object can be made correctly recognizable.

### Third Example Embodiment

Next, a robot system 1 according to a third example embodiment of the present disclosure will be explained. FIG. 18 is a diagram illustrating an example of the configuration of the robot system 1 according to the third example embodiment of the present disclosure. The robot system 1 according to the third example embodiment, as shown in FIG. 18, includes a measurement device 10, a designation device 20, a control device 30, and a robot 40, like the robot system 1 according to the first example embodiment shown in FIG. 1. The robot system 1 according to the third example embodiment further includes a WMS (Warehouse System) 60 (an example of an external system). In the third example embodiment, as in the first example embodiment, objects M to be moved are placed on and parallel to a planar surface P that is oriented substantially horizontally.

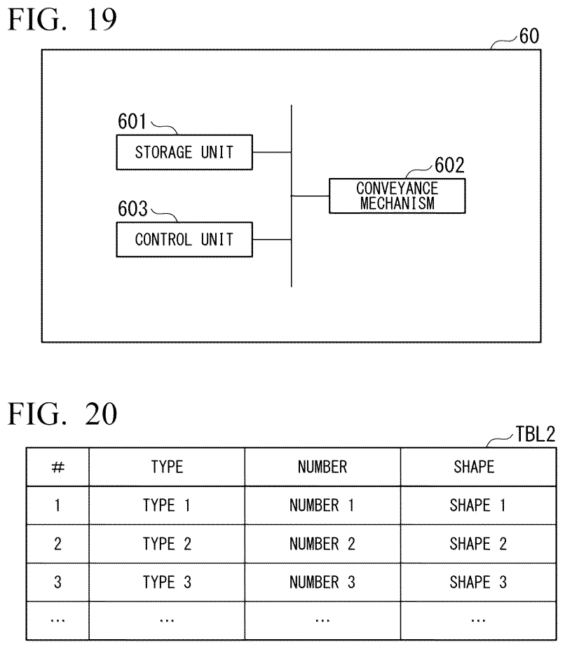

The WMS 60 is a system for managing the storage conditions for respective goods stocked in a warehouse, and the like. Examples of the storage conditions include the number, the shapes (including the dimensions), and the like of the respective goods. Additionally, the WMS 60 includes a conveyance mechanism for moving the goods to a storage location at the time of arrival and for moving the goods from the storage location to a work region of a robot 40 at the time of shipping. FIG. 19 is a diagram illustrating an example of the configuration of the WMS 60 according to the third example embodiment of the present disclosure. The WMS 60 includes a storage unit 601, a conveyance mechanism 602, and a control unit 603.

The storage unit 601 stores various types of information necessary for processes performed by the WMS 60. For example, the storage unit 601 stores the storage conditions of the respective goods. FIG. 20 is a diagram illustrating an example of a data table TBL2 stored in the storage unit 601 according to the third example embodiment of the present disclosure. The storage unit 601 stores, for example, the types, numbers, and shapes of goods (i.e., the objects M to be moved) stocked in respective trays T (#1, 2, 3, . . . ) in association with each other, as shown in FIG. 20.

The conveyance mechanism 602, under control by the control unit 603, moves goods to desired positions at the time of arrival and at the time of shipping. The robot system 1 according to the example embodiment of the present disclosure included in the WMS 60 will be explained under the assumption that goods have already been moved to a work region of the robot 40 (i.e., it is known how many of what sorts of goods were transported to the work region of the robot 40) under control by the control unit 603.

The control unit 603 controls the operations of the conveyance mechanism 602. Additionally, the control unit 603 transmits, to a designation device 20, information regarding the types, number, and shapes of goods moved to the work region of the robot 40 based on control thereof.

Next, the designation device 20 will be explained. The explanation below pertains to the process by which the designation device 20 designates the external form of an object M to be moved by using information regarding the storage conditions of respective goods stored in the storage unit 601 of the WMS 60.

The designation device 20, like the designation device 20 according to the first example embodiment shown in FIG. 5, includes a display unit 201, a generation unit 202, a control unit 203, and a reception unit 204.

Figures Fa that are to be candidates for being the external form F of objects M to be moved are prepared in advance. The generation unit 202 generates a control signal Cnt1 for making the display unit 201 display a two-dimensional image, as well as the figures Fa that are the candidates, based on information on the two-dimensional images captured by the camera 101 and the information regarding the types, number, and shapes of objects M to be moved, received from the WMS 60.

The control unit 203 makes the display unit 201 display the two-dimensional image captured by the camera 101, as well as the figures Fa that are the candidates for being the external form F of objects M to be moved, based on the control signal Cnt1 generated by the generation unit 202.

The reception unit 204 receives inputs by a worker designating (in this case, designating by selecting) a figure Fa that is a candidate for being the external form F. For example, the reception unit 204 is a touch panel. The reception unit 204 receives operations, by a finger of the worker, by a pen for use exclusively with the touch panel, and the like, to select a figure Fa, and to move the selected figure Fa to a desired position (i.e., a position on the upper surface of the actual object M to be moved, appearing in the two-dimensional image).

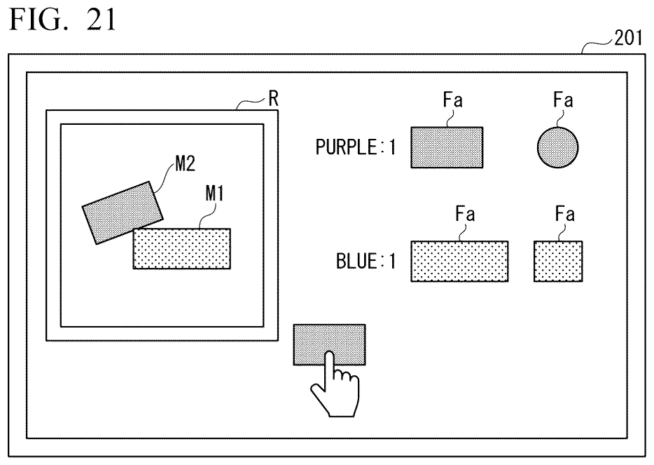

Even while the worker is performing the operations to move the selected figure Fa to the desired location, the generation unit 202 generates the control signal Cnt1 in accordance with the operations. During this time, the control unit 203 makes the display unit 201 display the two-dimensional image captured by the camera 101, as well as the figures Fa, based on the control signal Cnt1 generated by the generation unit 202. As a result thereof, the display unit 201, under control implemented by the control unit 203, displays the two-dimensional image captured by the camera 101, as well as the figures Fa. FIG. 21 is a diagram illustrating an example of an image displayed by the display unit 201 according to the third example embodiment of the present disclosure. In the example shown in FIG. 21, as the objects M to be moved, the objects M1 and M2, and the figures Fa are shown. Additionally, in the example shown in FIG. 21, the region R is shown. The hand shown in FIG. 21 is not displayed by the display unit 201, and is shown to illustrate an image of the case in which a worker has performed operations with a finger on a touch panel to move a figure Fa and to indicate the position of the figure Fa.

The designation device 20 may display just one figure Fa that is a candidate on the display unit 201, and may display other figures Fa on the display unit 201 in a case where a worker has performed an operation for selecting a candidate on the reception unit 204.

### (Advantages)

The robot system 1 according to the third example embodiment of the present disclosure has been explained above. In the designation device 20 of the robot system 1, the generation unit 202 generates a control signal Cnt1 for making the display unit 201 display a two-dimensional image, as well as the figures Fa, based on information on the two-dimensional images captured by the camera 101 and the information regarding the types, number, and shapes of objects M to be moved, received from the WMS 60. The control unit 203 makes the display unit 201 display the two-dimensional image captured by the camera 101, as well as the figures Fa that are to be candidates for being the external form F of an object M to be moved, based on the control signal Cnt1 generated by the generation unit 202. The reception unit 204 receives inputs by a worker designating (in this case, designating by selecting) a figure Fa that is a candidate for being the external form F. For example, the reception unit 204 is a touch panel, and receives operations, by a finger of the worker, by a pen for use exclusively with the touch panel, and the like, to select a figure Fa, and to move the selected figure Fa to a desired position (i.e., a position on the upper surface of the actual object M to be moved, appearing in the two-dimensional image).

By doing so, the designation device 20 displays the two-dimensional image including the objects M to be moved, as well as figures Fa in accordance with the objects M to be moved. Therefore, in a case where the worker uses the designation device 20, the worker can designate the position of a figure Fa while checking the positional relationship between the two-dimensional image including the objects M and the figure Fa. Additionally, since the image displayed by the designation device 20 is two-dimensional, the worker merely needs to move the figure Fa to a desired position in the image. For this reason, the operations for the worker to designate the shape U can be easily performed. Thus, due to the designation device 20, in a robot system that, in a case where the pre-movement state of an object is input, moves that object by following a predetermined algorithm in accordance with a work goal, a worker can easily designate the state of the object. As a result thereof, even if the robot system cannot correctly recognize an object, the object can be made correctly recognizable.

### Modified Example of Third Example Embodiment

Next, a robot system 1 according to a modified example of the third example embodiment of the present disclosure will be explained. The robot system 1 according to the modified example of the third example embodiment, like the robot system 1 according to the third example embodiment shown in FIG. 18, includes a measurement device 10, a designation device 20, a control device 30, a robot 40, and a WMS 60. In the modified example of the third example embodiment, like the modified example of the first example embodiment, the objects M to be moved are assumed to be placed at an incline with respect to the planar surface P.

The designation device 20, like the designation device 20 according to the first example embodiment shown in FIG. 5, includes a display unit 201, a generation unit 202, a control unit 203, and a reception unit 204.

Figures Fa that are to be candidates for being a surface Qa for designating a predetermined surface of an object M to be moved and an axis Qb forming a predetermined angle with respect to the surface Qa are prepared in advance. The generation unit 202 generates a control signal Cnt1 for making the display unit 201 display the two-dimensional image, as well as the figures Fa that are the candidates, based on information on the two-dimensional images captured by the camera 101 and the information regarding the types, number, and shapes of objects M to be moved, received from the WMS 60.

The control unit 203 makes the display unit 201 display the two-dimensional image captured by the camera 101, as well as the figures Fa that are the candidates for being a surface Qa for designating predetermined surfaces of the objects M to be moved and an axis Qb forming a predetermined angle with respect to the surface Qa, based on the control signal Cnt1 generated by the generation unit 202.

The reception unit 204 receives inputs by a worker designating (in this case, designating by selecting) a figure Fa that is a candidate for being a surface Qa for designating a predetermined surface of the object M to be moved and an axis Qb forming a predetermined angle with respect to the surface Qa. For example, the reception unit 204 is a touch panel, and receives operations, by a finger of the worker, by a pen for use exclusively with the touch panel, and the like, to select a figure Fa, and to move the selected figure Fa to a desired position (i.e., a position on the upper surface of the actual object M to be moved, appearing in the two-dimensional image).

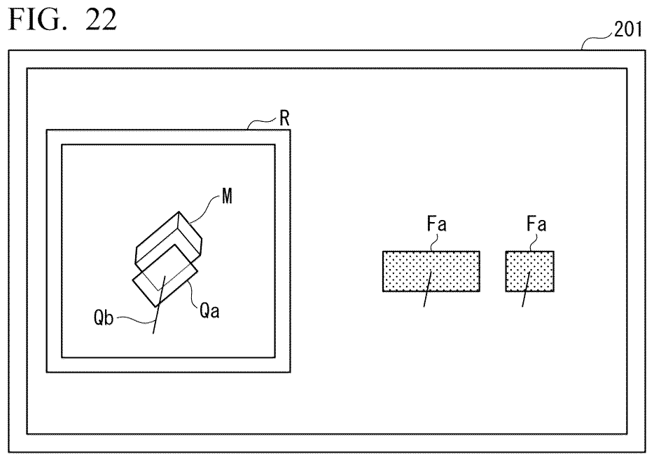

Even while the worker is performing the operations to move the selected figure Fa to the desired location, the generation unit 202 generates the control signal Cnt1 in accordance with the operations. Then, the control unit 203 makes the display unit 201 display the two-dimensional image captured by the camera 101, as well as the figures Fa, based on the control signal Cnt1 generated by the generation unit 202. As a result thereof, the display unit 201, under control implemented by the control unit 203, displays the two-dimensional image captured by the camera 101, as well as the figures Fa. FIG. 22 is a diagram illustrating an example of an image displayed by the display unit 201 according to the modified example of the third example embodiment of the present disclosure. In the example shown in FIG. 22, as the objects M to be moved, the object M, and the figures Fa are shown. Additionally, in the example shown in FIG. 22, the region R is shown. The hand shown in FIG. 22 is not displayed by the display unit 201, and is shown to illustrate an image of the case in which a worker has performed operations with a finger on a touch panel to move a figure Fa and to indicate the position of the figure Fa.

The designation device 20 may display just one figure Fa that is a candidate on the display unit 201, and may display other figures Fa on the display unit 201 in a case where a worker has performed an operation for selecting a candidate on the reception unit 204.

### (Advantages)

The robot system 1 according to the third example embodiment of the present disclosure has been explained above. In the designation device 20 of the robot system 1, the generation unit 202 generates a control signal Cnt1 for making the display unit 201 display a two-dimensional image, as well as the figures Fa, based on information on the two-dimensional images captured by the camera 101 and the information regarding the types, number, and shapes of objects M to be moved, received from the WMS 60. The control unit 203 makes the display unit 201 display the two-dimensional image captured by the camera 101, as well as the figures Fa that are candidates for being the surface Qa and the axis Qb forming a predetermined angle with respect to the surface Qa, based on the control signal Cnt1 generated by the generation unit 202. The reception unit 204 receives inputs by a worker designating (in this case, designating by selecting) a figure Fa that is a candidate for being the surface Qa and the axis Qb forming a predetermined angle with respect to the surface Qa. For example, the reception unit 204 is a touch panel, and receives operations, by a finger of the worker, by a pen for use exclusively with the touch panel, and the like, to select a figure Fa, and to move the selected figure Fa to a desired position (i.e., a position on the upper surface of the actual object M to be moved, appearing in the two-dimensional image).

By doing so, the designation device 20 displays the two-dimensional image including the object M to be moved, as well as figures Fa that have been prepared in advance in accordance with the objects M to be moved. Therefore, in a case where the worker uses the designation device 20, the worker can designate the position of a figure Fa while checking the positional relationship between the two-dimensional image including the objects M and the figure Fa. Additionally, since the image displayed by the designation device 20 is two-dimensional, the worker merely needs to move the figure Fa to a desired position in the image. For this reason, the operations for the worker to designate the shape U can be easily performed. Thus, due to the designation device 20, in a robot system that, in a case where the pre-movement state of an object is input, moves that object by following a predetermined algorithm in accordance with a work goal, a worker can easily designate the state of the object. As a result thereof, even if the robot system cannot correctly recognize an object, the object can be made correctly recognizable.

### Fourth Example Embodiment

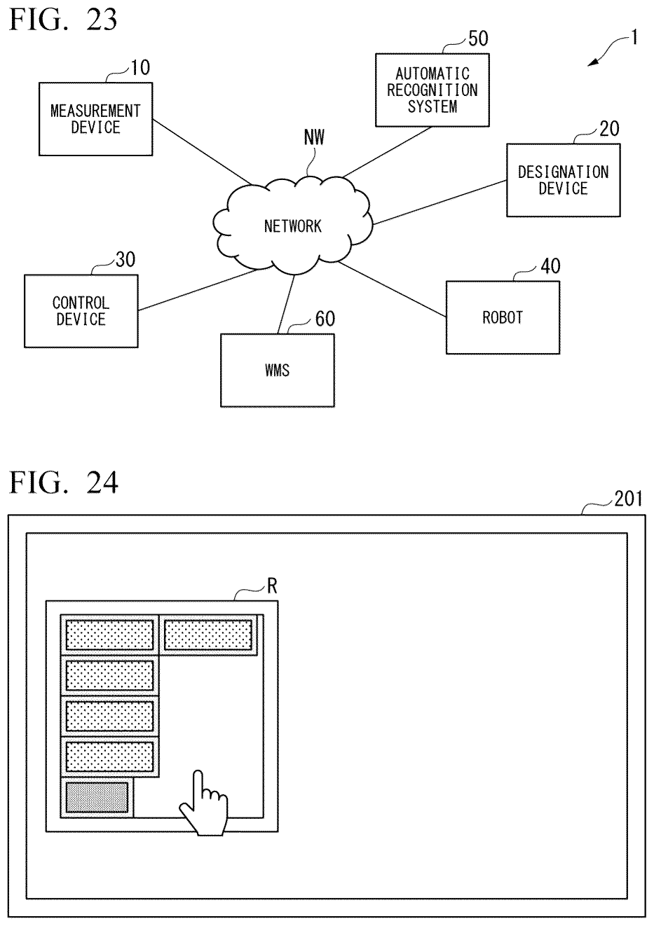

Next, a robot system 1 according to a fourth example embodiment of the present disclosure will be explained. FIG. 23 is a diagram illustrating an example of the configuration of the robot system 1 according to the fourth example embodiment of the present disclosure. The robot system 1 according to the fourth example embodiment, as shown in FIG. 23, includes a measurement device 10, a designation device 20, a control device 30, a robot 40, an automatic recognition system 50, and a WMS 60. In the fourth example embodiment, as in the first example embodiment, objects M to be moved are placed on and parallel to a planar surface P that is oriented substantially horizontally.

The robot system 1 according to the fourth example embodiment is a system with a configuration combining the robot system 1 according to the second example embodiment and the robot system 1 according to the third example embodiment.

While the designation device 20 generates a shape U indicating the upper surface of an object M to be moved based on information received from the automatic recognition system 50, in a case where the shape U does not have a desired position and shape with size indicating the external form of an object M to be moved, instead of correcting the shape U, the figures Fa explained in the third example embodiment are used to designate the external form of the object M to be moved.

Thus, the process in the designation device 20 merely involves performing the process for presenting the display on the display unit 201 in the second example embodiment, and in a case where the shape U is mismatched with the external form of the object M to be moved, performing the process for presenting the display on the display unit 201 in the third example embodiment.

### (Advantages)

The robot system 1 according to the fourth example embodiment of the present disclosure has been explained above. By combining the configuration of the robot system 1 according to the second example embodiment with the configuration of the robot system 1 according to the third example embodiment, the process for presenting the display on the display unit 201 in the second example embodiment can be performed. Additionally, in a case where the shape U is mismatched from the external form of an object M to be moved, the external form of the object M to be moved can be correctly designated by performing the process for presenting the display on the display unit 201 in the third example embodiment. As a result thereof, even if the robot system cannot correctly recognize an object, the object can be made correctly recognizable.

### Modified Example of Fourth Example Embodiment

Next, a robot system 1 according to a modified example of the fourth example embodiment of the present disclosure will be explained. The robot system 1 according to the modified example of the fourth example embodiment, like the robot system 1 according to the fourth example embodiment shown in FIG. 23, includes a measurement device 10, a designation device 20, a control device 30, a robot 40, an automatic recognition system 50, and a WMS 60. In the modified example of the fourth example embodiment, like the modified example of the first example embodiment, the objects M to be moved are assumed to be placed at an incline with respect to the planar surface P.

The robot system 1 according to the modified example of the fourth example embodiment is a system including a configuration combining the robot system 1 according to the modified example of the second example embodiment with the robot system 1 according to the modified example of the third example embodiment.

### (Advantages)

The robot system 1 according to the fourth example embodiment can be contemplated similarly with the robot system 1 according to the fourth example embodiment. By combining the configuration of the robot system 1 according to the modified example of the second example embodiment with the configuration of the robot system 1 according to the modified example of the third example embodiment, the process for presenting the display on the display unit 201 in the modified example of the second example embodiment can be performed. Additionally, in a case where a figure Fa is mismatched from the predetermined planar surface of an object M to be moved, the predetermined planar surface of the object M to be moved can be correctly designated by performing the process for presenting the display on the display unit 201 in the modified example of the third example embodiment. As a result thereof, even if the robot system cannot correctly recognize an object, the object can be made correctly recognizable.

### Fifth Example Embodiment

Next, a robot system 1 according to a fifth example embodiment of the present disclosure will be explained. The robot system 1 according to the fifth example embodiment, like the robot system 1 according to the first example embodiment shown in FIG. 1, includes a measurement device 10, a designation device 20, a control device 30, and a robot 40. The robot system 1 according to the fifth example embodiment is a system for changing the movement destination of the robot 40.

In a case where a robot 40, under control by the control device 30, has moved an object M to be moved to a movement destination determined by the control device 30 by following an algorithm, there is a possibility that the movement destination thereof will not be a movement destination desired by a worker. The robot system 1 according to the fifth example embodiment is a system for executing a process to change the movement destination to the desired movement destination in such cases.

The explanation below is for a process for changing a movement destination that has been identified by the control device 30 by following an algorithm after the pre-movement states of objects M to be moved have been designated in the robot system 1 of the first example embodiment and the modified example thereof described above.

In the robot system 1, a movement destination is determined in a case where the control signal Cnt2 is determined in accordance with an algorithm. The control unit 304 outputs information indicating this movement destination to the designation device 20.

The generation unit 202 generates a control signal Cnt1 for making the display unit 201 display a two-dimensional image and a movement destination, as well as an external form F for designating the movement destination, based on information on the two-dimensional images captured by the camera 101, the information for designating the external form F explained for the first example embodiment, and information indicating the movement destination received from the control device 30.

The control unit 203 makes the display unit 201 display the two-dimensional image captured by the camera 101 and the movement destination, as well as the external form F, based on the control signal Cnt1 generated by the generation unit 202.

The reception unit 204 receives operations by a worker to delete an unneeded movement destination. For example, the reception unit 204 is a touch panel, and receives operations, by a finger of the worker, by a pen for use exclusively with the touch panel, and the like, to select the movement destination to be deleted, and to determine that the selected movement destination is to be deleted. In a case where the reception unit 204 receives these operations, the generation unit 202 generates a control signal Cnt1 for not displaying the movement destination that has been designated to be deleted. This control signal Cnt1 causes the movement destination to be deleted.

Additionally, the reception unit 204 receives operations to move the external form F to a desired position (i.e., a desired movement destination). Additionally, the reception unit 204 receives inputs by the worker designating (in this case, designating by selecting) the external form F. For example, the reception unit 204 is a touch panel, and receives operations, by a finger of the worker, by a pen for use exclusively with the touch panel, and the like, to select the external form F, and to move the selected external form F to a desired position (i.e., to a desired movement destination).

Even while the worker is performing the operations to move the selected external form F to the desired location and the operations to delete the movement destination, the generation unit 202 generates the control signal Cnt1 in accordance with the operations. Then, the control unit 203 makes the display unit 201 display the two-dimensional image captured by the camera 101 and the external form F, which is the desired movement destination, based on the control signal Cnt1 generated by the generation unit 202. As a result thereof, the display unit 201, under control implemented by the control unit 203, displays the two-dimensional image captured by the camera 101, as well as the external form F, which is the desired movement destination.

FIG. 24 is a diagram illustrating an example of movement destinations determined by the control device 30 according to the fifth example embodiment of the present disclosure. As shown in FIG. 24, there is a possibility that the movement destinations include a mix of regions in which objects M are densely located and regions in which there are no objects M. Even in this case, a movement destination can be changed to a movement destination desired by the worker by the process described above.

### (Advantages)

The robot system 1 according to the fifth example embodiment of the present disclosure has been explained above. As described above, the technology for designating the state of an object M to be moved can also be used in technology for designating a movement destination. Thus, a worker can easily, by means of the designation device 20, designate the post-movement state of an object in a robot system that, in a case where the pre-movement state of an object is input, moves that object by following a predetermined algorithm in accordance with a work goal. As a result thereof, even if the robot system cannot correctly recognize an object, the object can be made correctly recognizable.

### Sixth Example Embodiment

Next, a robot system 1 according to a sixth example embodiment of the present disclosure will be explained. The robot system 1 according to the sixth example embodiment, like the robot system 1 according to the third example embodiment shown in FIG. 18, includes a measurement device 10, a designation device 20, a control device 30, a robot 40, and a WMS 60. The robot system 1 according to the sixth example embodiment is a system for changing the movement destination of the robot 40.

In a case where a robot 40, under control by the control device 30, has moved an object M to be moved to a movement destination determined by the control device 30 by following an algorithm, there is a possibility that the movement destination thereof will not be a movement destination desired by a worker. The robot system 1 according to the sixth example embodiment is a system for executing a process to change the movement destination to the desired movement destination in such cases.

The explanation below is for a process in a robot system 1 included in a WMS 60 among the robot systems 1 in the first to fourth example embodiments and modified examples thereof described above. Specifically, the process is for changing a movement destination that has been identified by the control device 30 by following an algorithm after the pre-movement states of objects M to be moved have been designated.

In the robot system 1, a movement destination is determined in a case where the control signal Cnt2 is determined in accordance with the algorithm. The control unit 304 outputs information indicating this movement destination to the designation device 20.

The generation unit 202 generates a control signal Cnt1 for making the display unit 201 display a two-dimensional image and a movement destination, as well as figures Fa, based on information on the two-dimensional images captured by the camera 101, information regarding the types, the number, and the shapes of objects M to be moved received from the WMS 60, and information indicating the movement destination received from the control device 30.

The control unit 203 makes the display unit 201 display the two-dimensional image captured by the camera 101 and the movement destination, as well as figures Fa, based on the control signal Cnt1 generated by the generation unit 202.

The reception unit 204 receives operations by a worker to delete an unneeded movement destination. For example, the reception unit 204 is a touch panel, and receives operations, by a finger of the worker, by a pen for use exclusively with the touch panel, and the like, to select the movement destination to be deleted, and to determine that the selected movement destination is to be deleted. In a case where the reception unit 204 receives these operations, the generation unit 202 generates a control signal Cnt1 for not displaying the movement destination that has been designated to be deleted. This control signal Cnt1 causes the movement destination to be deleted.

Additionally, the reception unit 204 receives operations to move a figure Fa to a desired position (i.e., a desired movement destination). Additionally, the reception unit 204 receives inputs by a worker designating (in this case, designating by selecting) a figure Fa. For example, the reception unit 204 is a touch panel, and receives operations, by a finger of the worker, by a pen for use exclusively with the touch panel, and the like, to select a figure Fa, and to move the selected figure Fa to a desired position (i.e., to a desired movement destination).

Even while the worker is performing the operations to move the selected figure Fa to the desired location and the operations to delete the movement destination, the generation unit 202 generates the control signal Cnt1 in accordance with the operations, and the control unit 203 makes the display unit 201 display the two-dimensional image captured by the camera 101 and the figure Fa, which is the desired movement destination, based on the control signal Cnt1 generated by the generation unit 202. As a result thereof, the display unit 201, under control implemented by the control unit 203, displays the two-dimensional image captured by the camera 101, as well as the figure Fa, which is the desired movement destination.

In the sixth example embodiment of the present disclosure also, as shown in FIG. 24, there is a possibility that the movement destinations include a mix of regions in which objects M are densely located and regions in which there are no objects M. Even in this case, a movement destination can be changed to a movement destination desired by the worker by the processes described above.

### (Advantages)

The robot system 1 according to the sixth example embodiment of the present disclosure has been explained above. As described above, the technology for designating the state of an object M to be moved can also be used in technology for designating a movement destination. Thus, a worker can easily, by means of the designation device 20, designate the post-movement state of an object in a robot system that, in a case where the pre-movement state of an object is input, moves that object by following a predetermined algorithm in accordance with a work goal. As a result thereof, even if the robot system cannot correctly recognize an object, the object can be made correctly recognizable.

### Seventh Example Embodiment

Next, a robot system 1 according to a seventh example embodiment of the present disclosure will be explained. The robot system 1 according to the seventh example embodiment, like the robot system 1 according to the second example embodiment shown in FIG. 13, includes a measurement device 10, a designation device 20, a control device 30, and a robot 40, and further includes an automatic recognition system 50.

The robot system 1 includes the automatic recognition system 50, and in a case where the robot 40, under control by the control device 30, has moved an object M to be moved to a movement destination determined by the control device 30 by following an algorithm, the automatic recognition system 50 generates information indicating the movement destination. The robot system 1 according to the seventh example embodiment is a system that executes a process for changing the movement destination to a desired movement destination in such cases.

The automatic recognition system 50 outputs generated information indicating a movement destination to the designation device 20. The generation unit 202 generates a control signal Cnt1 for making the display unit 201 display a two-dimensional image and the movement destination, as well as an external form F, for designating the movement destination, based on information on the two-dimensional images captured by the camera 101, the information for designating the external form F explained in the first example embodiment, and the information indicating the movement destination received from the automatic recognition system 50.

The control unit 203 makes the display unit 201 display the two-dimensional image captured by the camera 101 and the movement destination, as well as the external form F, based on the control signal Cnt1 generated by the generation unit 202.

The reception unit 204 receives operations by a worker to delete an unneeded movement destination. For example, the reception unit 204 is a touch panel, and receives operations, by a finger of the worker, by a pen for use exclusively with the touch panel, and the like, to select a movement destination to be deleted, and to determine that the selected movement destination is to be deleted. In a case where the reception unit 204 receives these operations, the generation unit 202 generates a control signal Cnt1 for not displaying the movement destination that has been designated to be deleted. This control signal Cnt1 causes the movement destination to be deleted.

Additionally, the reception unit 204 receives operations to move the external form F to a desired position (i.e., a desired movement destination). Additionally, the reception unit 204 receives inputs by a worker designating (in this case, designating by selecting) the external form F. For example, the reception unit 204 is a touch panel, and receives operations, by a finger of the worker, by a pen for use exclusively with the touch panel, and the like, to select the external form F, and to move the selected external form F to a desired position (i.e., to a desired movement destination).

Even while the worker is performing the operations to move the selected external form F to the desired location and the operations to delete the movement destination, the generation unit 202 generates the control signal Cnt1 in accordance with the operations, and the control unit 203 makes the display unit 201 display the two-dimensional image captured by the camera 101 and the external form F, which is the desired movement destination, based on the control signal Cnt1 generated by the generation unit 202. As a result thereof, the display unit 201, under control implemented by the control unit 203, displays the two-dimensional image captured by the camera 101, as well as the external form F, which is the desired movement destination.

### (Advantages)

The robot system 1 according to the seventh example embodiment of the present disclosure has been explained above. As described above, the technology for designating the state of an object M to be moved can also be used in technology for designating a movement destination. Thus, a worker can easily, by means of the designation device 20, designate the post-movement state of an object in a robot system that, in a case where the pre-movement state of an object is input, moves that object by following a predetermined algorithm in accordance with a work goal. As a result thereof, even if the robot system cannot correctly recognize an object, the object can be made correctly recognizable.

### Eighth Example Embodiment

Next, a robot system 1 according to an eighth example embodiment of the present disclosure will be explained. The robot system 1 according to the eighth example embodiment, like the robot system 1 according to the fourth example embodiment shown in FIG. 23, includes a measurement device 10, a designation device 20, a control device 30, a robot 40, an automatic recognition system 50, and a WMS 60.

The robot system 1 includes the automatic recognition system 50, and in a case where the robot 40, under control by the control device 30, has moved an object M to be moved to a movement destination determined by the control device 30 by following an algorithm, the automatic recognition system 50 generates information indicating the movement destination. The robot system 1 according to the eighth example embodiment is a system that executes a process for changing the movement destination to a desired movement destination in such cases.

The automatic recognition system 50 outputs generated information indicating a movement destination to the designation device 20. The generation unit 202 generates a control signal Cnt1 for making the display unit 201 display a two-dimensional image and the movement destination, as well as figures Fa, based on information on the two-dimensional images captured by the camera 101, information regarding the types, the number, and the shapes of the objects M to be moved received from the WMS 60, and the information indicating the movement destination received from the automatic recognition system 50.

The control unit 203 makes the display unit 201 display the two-dimensional image captured by the camera 101 and the movement destination, as well as the figures Fa, based on the control signal Cnt1 generated by the generation unit 202.

The reception unit 204 receives operations by a worker to delete an unneeded movement destination. For example, the reception unit 204 is a touch panel, and receives operations, by a finger of the worker, by a pen for use exclusively with the touch panel, and the like, to select a movement destination to be deleted, and to determine that the selected movement destination is to be deleted. In a case where the reception unit 204 receives these operations, the generation unit 202 generates a control signal Cnt1 for not displaying the movement destination that has been designated to be deleted. This control signal Cnt1 causes the movement destination to be deleted.

Additionally, the reception unit 204 receives operations to move a figure Fa to a desired position (i.e., a desired movement destination). Additionally, the reception unit 204 receives inputs by a worker designating (in this case, designating by selecting) the figure Fa. For example, the reception unit 204 is a touch panel, and receives operations, by a finger of the worker, by a pen for use exclusively with the touch panel, and the like, to select the figure Fa, and to move the selected figure Fa to a desired position (i.e., to a desired movement destination).

Even while the worker is performing the operations to move the selected figure Fa to the desired location and the operations to delete the movement destination, the generation unit 202 generates the control signal Cnt1 in accordance with the operations, and the control unit 203 makes the display unit 201 display the two-dimensional image captured by the camera 101 and the figure Fa, which is the desired movement destination, based on the control signal Cnt1 generated by the generation unit 202. As a result thereof, the display unit 201, under control implemented by the control unit 203, displays the two-dimensional image captured by the camera 101, as well as the figure Fa, which is the desired movement destination.

### (Advantages)

The robot system 1 according to the eighth example embodiment of the present disclosure has been explained above. As described above, the technology for designating the state of an object M to be moved can also be used in technology for designating a movement destination. Thus, a worker can easily, by means of the designation device 20, designate the post-movement state of an object in a robot system that, in a case where the pre-movement state of an object is input, moves that object by following a predetermined algorithm in accordance with a work goal. As a result thereof, even if the robot system cannot correctly recognize an object, the object can be made correctly recognizable.

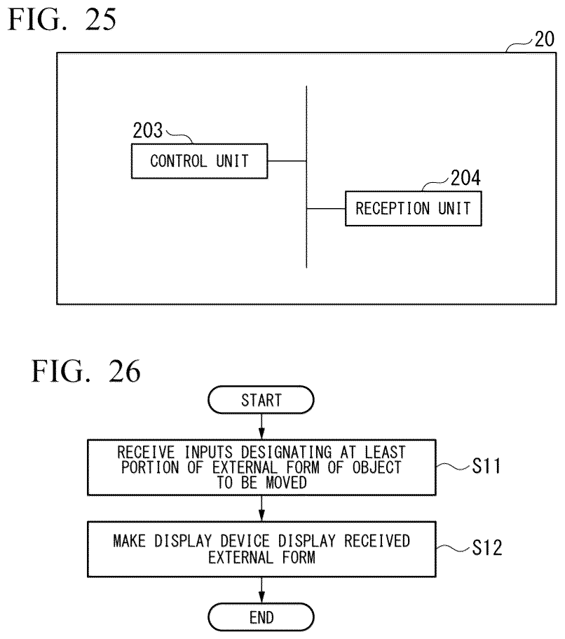

A designation device 20 with the minimum configuration according to an example embodiment of the present disclosure will be explained. FIG. 25 is a diagram illustrating the designation device 20 with the minimum configuration according to an example embodiment of the present disclosure. The designation device 20 with the minimum configuration according to the example embodiment of the present disclosure is a designation device in a robot system that moves an object to be moved by following a designated algorithm in accordance with a work goal, and as shown in FIG. 25, includes a reception unit 204 (an example of reception means) and a control unit 203 (an example of control means). The reception unit 204 receives inputs designating at least a portion of the external form of an object to be moved. The control unit 203 makes the display device display the two-dimensional image including the object to be moved, as well as the external form received by the reception unit. The reception unit 204 can, for example, be realized by using the functions of the reception unit 204 included in the designation device 20 according to the modified example of the first example embodiment. Additionally, the control unit 203 can, for example, be realized by using the functions of the control unit 203 included in the designation device 20 according to the modified example of the first example embodiment.

Next, the process in the designation device 20 with the minimum configuration will be explained. FIG. 26 is a diagram illustrating an example of the processing flow in the designation device 20 with the minimum configuration. In this case, the process in the designation device 20 with the minimum configuration will be explained with reference to FIG. 26.

In the designation device 20 in the robot system that moves an object to be moved by following a predetermined algorithm in accordance with a work goal, the reception unit 204 receives inputs designating at least a portion of the external form of the object to be moved (step S11). The control unit 203 makes a display device display a two-dimensional image including the object to be moved, as well as the external form received by the reception unit (step S12). By doing so, the designation device 20, in a robot system that, in a case where the pre-movement state of an object is input, moves that object by following a predetermined algorithm in accordance with a work goal, can allow a worker to easily designate the state of the object. As a result thereof, even if the robot system cannot correctly recognize an object, the object can be made correctly recognizable.

In the processes in the example embodiments of the present disclosure, the order of the processes may be switched within the range in which appropriate processes are performed.

While example embodiments of the present disclosure have been explained, the robot system 1, the measurement device 10, the designation device 20, the control device 30, the robot 40, the automatic recognition system 50, the WMS 60, and other control devices described above may include internal computer devices. Furthermore, the steps in the processes described above are stored in a computer-readable recording medium in the form of a program, and the processes described above are performed by a computer reading and executing this program. A specific example of the computer is indicated below.

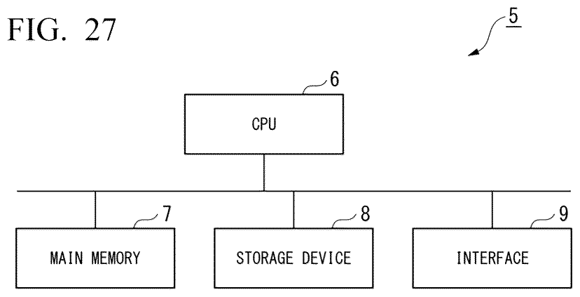

FIG. 27 is a schematic block diagram illustrating the configuration of a computer according to at least one example embodiment. The computer 5, as shown in FIG. 27, includes a CPU 6 (including a vector processor), a main memory 7, a storage device 8, and an interface 9. For example, the robot system 1, the measurement device 10, the designation device 20, the control device 30, the robot 40, the automatic recognition system 50, the WMS 60, and other control devices described above are implemented in a computer 5. Furthermore, the operations of the respective processing units described above are stored in the storage device 8 in the form of a program. The CPU 6 reads the program from the storage device 8, loads the program in the main memory 7, and executes the processes described above in accordance with the program. Additionally, the CPU 6 secures storage areas corresponding to the respective storage units described above in the main memory 7 in accordance with the program.

Examples of the storage device 8 include an HDD (Hard Disk Drive), an SSD (Solid-State Drive), a magnetic disk, a magneto-optic disk, a CD-ROM (Compact Disc Read-Only Memory), a DVD-ROM (Digital Versatile Disc Read-Only Memory), a semiconductor memory, and the like. The storage device 8 may be internal media directly connected to a bus of the computer 5, or may be external media connected to the computer 5 via an interface 9 or a communication line. Additionally, in a case where this program is distributed to the computer 5 by a communication line, the computer 5 that has received the distribution may load the program in the main memory 7 and execute the processes described above. In at least one example embodiment, the storage device 8 is a non-transitory, tangible storage medium.

Additionally, the program described above may realize just some of the functions described above. Furthermore, the program described above may be a so-called difference file (difference program), which is a file that can realize the functions described above by being combined with a program already recorded in the computer device.

While some example embodiments of the present disclosure have been explained, these example embodiments are merely examples, and do not limit the scope of the disclosure. Various additions, omissions, substitutions, or modifications may be made to these example embodiments within a range not departing from the spirit of the disclosure.

### INDUSTRIAL APPLICABILITY

According to the example embodiments of the present disclosure, in a robot system that, in a case where the pre-movement state of an object is input, moves that object by following a predetermined algorithm in accordance with a work goal, a worker can easily designate the state of the object.

### REFERENCE SIGNS LIST

1 Robot system
5 Computer
6 CPU
7 Main memory
8 Storage device
9 Interface
10 Measurement device
20 Designation device
30 Control device
40 Robot
50 Automatic recognition system
60 WMS
101, 102, 501 Camera
201 Display unit
202, 401 Generation unit
203, 304, 603 Control unit
204 Reception unit
301, 601 Storage unit
302 Acquisition unit
303 Identification unit
402 Movable device
402a Grasping unit
F External form
M, M1, M2 Object to be moved
NW Network
P Planar surface
R Image capture region
T Tray

What is claimed is:

1. A designation device comprising:
a memory configured to store instructions; and
a processor configured to execute the instructions to:
receive an input designating at least a portion of an external form of an object to be moved in a robot system that moves the object to be moved by following a predetermined algorithm in accordance with a work goal; and
make a display device display a two-dimensional image including the object to be moved, and the external form received by the reception means.

2. The designation device according to claim 1, wherein the processor is configured to execute the instructions to receive the input of the external form as a shape defined by tracing the external form of the object to be moved.

3. The designation device according to claim 1, wherein the processor is configured to execute the instructions to receive the input of the external form as a shape defined by designating a vertex of the object to be moved.

4. The designation device according to claim 1, wherein the processor is configured to execute the instructions to receive an input for changing a shape generated based on data in an external system that manages the object to be moved.

5. The designation device according to claim 1, wherein the processor is configured to execute the instructions to receive an input for changing a shape generated by an external system capturing an image of the object to be moved.

6. A robot system comprising:
the designation device according to claim 1;
a robot configured to be capable of grasping an object to be moved; and
a control device configured to make the robot grasp the object to be moved based on an external form of the object to be moved, received by the designation device.

7. A designation method executed by a computer, comprising:
receiving an input designating at least a portion of an external form of an object to be moved in a robot system that moves the object to be moved by following a predetermined algorithm in accordance with a work goal; and
making a display device display a two-dimensional image including the object to be moved, and the external form that has been received.

8. A non-transitory recording medium storing a program for causing a computer to:
receive an input designating at least a portion of an external form of an object to be moved in a robot system that moves the object to be moved by following a predetermined algorithm in accordance with a work goal; and
make a display device display a two-dimensional image including the object to be moved, and the external form that has been received.
